(19) United States
(12) Patent Application Publication
(10) Pub. No.: US 2026/0187362 A1
(43) Pub. Date: Jul. 2, 2026

(54) GENERATIVE SERVICE FOR CREATING MESSAGE CONTENT USING TRACKED PRODUCT USAGE DATA AND PRE-PROCESSED VECTORIZED DATA

(71) Applicant: Atlassian Pty Ltd., Sydney (AU)

(72) Inventors: Yashwanth Ram Ganti, Redmond, WA (US); Yang Li, Sunnyvale, CA (US); Kaleb Mills, Wichita, KS (US); Jingjing Peng, Cupertino, CA (US); Vinod Ramakrishnan, Fremont, CA (US); Kshitij Rajiv, New York, NY (US); Fan Jiang, Mountain View, CA (US); Akhilesh Kaza, Sammamish, WA (US)

(21) Appl. No.: 19/004,447

(22) Filed: Dec. 29, 2024

(51) Int. Cl. G06F 40/20; G06F 16/242; G06F 16/2455

(52) U.S. Cl. CPC G06F 40/20; G06F 16/242; G06F 16/2455

(57) ABSTRACT

Embodiments relate to systems and methods for generating content for a draft message based on tracked product data and pre-processed vectorized data. The methods can include extracting a customer domain identifier from a request and using the customer domain identifier to obtain from a product model a proposed product profile and a proposed product action. The methods can include constructing a first query comprising a semantic-based search criteria and a keyword-based search criteria and obtaining a first set of search results from an internal data store using the first query. The methods can include constructing a second query comprising a search vector and obtaining a second set of search results from a second data store using the second query. The methods can include causing generation of a prompt that includes the proposed product action obtained from the product model, and the composite set of search results satisfying a relevance metric.

### TECHNICAL FIELD

Embodiments described herein relate to multi-tenant services of collaborative work environments and, in particular, to systems and methods for operating a generative interface that produces generative content based on user specific inputs.

### BACKGROUND

An organization can employ software tools to assist with generating content. However, the information contained in a large system may be difficult to access in an efficient interface and information that resides in disparate locations in the system or that is entered over a period of time may be difficult to compile and access when managing a large quantity of data. The systems and techniques described herein may be used to provide improved content generation in a way that mitigates technical deficiencies of some traditional interfaces and systems.

### SUMMARY

Embodiments described herein are directed to systems and methods for generating content for a draft message based on tracked product usage data and pre-processed vectorized data. The methods can include extracting a customer domain identifier from a request in response to receiving the request from a client device, and using the customer domain identifier to obtain from a product model a proposed product profile and a proposed product action. The methods can include using the customer domain identifier and the proposed product profile to construct a first query comprising a semantic-based search criteria and a keyword-based search criteria. The methods can include obtaining a first set of search results from an internal data store using the first query. The internal data store can include product usage data with respect to a customer account associated with the customer domain identifier. The methods can include using the customer domain identifier and the proposed product profile to construct a second query comprising a search vector and obtaining a second set of search results from a second data store using the second query. The second data store can include vectorized content obtained from an external data source. The methods can include analyzing the first set of search results and the second set of search results to compute a relevance score using the proposed product profile and the proposed product action, and generating a composite set of results including at least a portion of the first set of search results and the second set of search results having a relevance score satisfying a relevance metric. The methods can include causing generation of a prompt that includes the proposed product action obtained from a product model, and the composite set of search results satisfying the relevance metric. The methods can include providing the prompt to a generative output engine to receive a generative response, analyzing the generative response to generate a natural language proposed message body, and causing display of the natural language proposed message body in a draft of a content item of a communication interface. In response to a user input provided to the communication interface, the methods can include causing the draft of the content item to be transmitted to a recipient associated with the customer domain identifier.

Embodiments described herein are also directed to systems and methods for generating content for a draft message based on tracked product usage data and pre-processed vectorized data. The methods can include, in response to receiving a request from a client device, extracting a customer domain identifier from the request, and using the customer domain identifier to obtain from a product model a recommendation output for a customer account associated with the customer domain identifier. The methods can include using the customer domain identifier and the recommendation output to construct a first query comprising a semantic-based search criteria and a keyword-based search criteria, and obtaining a first set of search results from an internal data store using the first query. The internal data store can include product usage data with respect to one or more customer accounts including the customer account associated with the customer domain identifier. The method can include using the customer domain identifier and the recommendation output to construct a second query comprising a search vector, and obtaining a second set of search results from a second data store using the second query. The second data store can include vectorized content generated from an external data source. The methods can include generating a composite set of results including search results from the first set of search result and the second set of search results having a respective relevance score satisfying a relevance metric. The methods can include causing generation of a prompt including the recommendation output obtained from the product model, and the composite set of search results, providing the prompt to a generative output engine to receive a generative response, and analyzing the generative response to generate a natural language proposed message body. The methods can include causing display of the natural language proposed message body in a draft of a content item of a communication interface and in response to a user input provided to the communication interface, causing the content item to be transmitted to a recipient associated with the customer domain identifier.

Embodiments are further directed to a content generation system backend application operating on one or more servers. The content generation system backend application can be operably coupled to a frontend application operating on a client device. The content generation system backend application can be configured to extract a customer domain identifier from a request received by the content generation system backend application, and obtain from a product model recommendation output using the customer domain identifier. The backend application can be configured to construct a first query comprising a semantic-based search criteria and a keyword-based search criteria using the recommendation output and obtain a first set of search results from an internal data store using the first query. The internal data store can include product usage data with respect to a customer account associated with the customer domain identifier. The backend application can be configured to construct a second query comprising a search vector using the customer domain identifier and the recommendation output, and obtain a second set of search results from a second data store using the second query. The second data store can include vectorized content obtained from an external data source. The backend application can be configured to generate a composite set of results including at least a portion of the first set of search results and the second set of search results having a relevance score satisfying a relevance metric. The backend application can be configured to cause generation of a prompt including the recommendation output and the composite set of search results satisfying the relevance metric, provide the prompt to a generative output engine to receive a generative response, and analyze the generative response to generate a natural language proposed message body. The frontend application can cause display of the natural language proposed message body in a draft of a content item of a communication interface. In response to a user input provided to the communication interface, the system causes the draft of the content item to be transmitted to a recipient associated with the customer domain identifier.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a simplified diagram of a system, such as described herein that can include and/or may receive input from a generative output engine.

FIG. 2 depicts an example system for generating content for a draft message based on product usage data, as described herein.

FIG. 3A depicts a simplified diagram of a system, such as described herein that can include and/or may receive input from a generative output engine.

FIG. 3B depicts a functional system diagram of a system that can be used to implement a multiplatform prompt management service.

FIG. 4A depicts a simplified system diagram and data processing pipeline.

FIG. 4B depicts a system providing multiplatform prompt management as a service.

FIG. 5 depicts an example schematic for obtaining product data and generating composite data for a prompt used at a generative output engine, as described herein.

FIG. 6 depicts an example process for generating content based on tracked product data and retrieved third-party data, as described herein.

FIG. 7 depicts an example interface that includes a draft of a content item including a natural language proposed message body.

FIG. 8 shows a sample electrical block diagram of an electronic device.

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein are related to systems and methods for generating message content using tracked product usage data and pre-processed third-party data. The systems and processes can be configured to generate customer-specific message content that is generated using tracked product data associated with a particular customer account and/or third-party data retrieved from a third-party data source. The system and methods can utilize a generative output engine and receive generative content to generate the customer-specific message content. The systems and methods can include generating a prompt that includes instructions for the generative output engine and data that is based on product data and third-party data that is associated with a particular user account. Accordingly, the system and methods described herein can generate message content that is unique to a particular customer and includes content that is generated using customer-specific data.

In some cases, the methods described herein can be initiated by a request received from a client device. The requested content can be content for an email message. An email interface may be displayed on a client device and the system can cause display of a selectable object for initiating the content generation process in the email interface. The email interface can be configured to collect information from the client device that is used to generate the message content. For example, the email interface can be configured to determine a customer domain identifier, which may be associated with and used to identify a particular customer account. In some cases, a user of the client device can input information about a particular customer, which can include the customer domain identifier. The customer domain identifier can be transferred from the email interface, to the content generation system, and used to generate message content as described herein.

The content generation system can use the customer domain identifier to retrieve data associated with the particular customer account from multiple different data sources. The content generation system can use the customer domain identifier to obtain a recommendation output from a product model. The product model can be a model that is trained using customer specific data, product usage data, and other data related to products of a multi-platform computing environment, and is configured to output a recommendation specific to a particular customer account. In some cases, the recommendation output from the product model can include a proposed product profile and a proposed product action.

The proposed product profile can specify one or more product recommendations for products that are not currently associated with a particular user account but are determined by the product model to be relevant to the particular user account. For example, a multi-platform computing environment may include one or more integrated software platforms such as a content collaboration system, an issue tracking system, project management system, code development system, and so on. Each different software platform may have different product configurations that include different features, are intended for different numbers of users and so on. The proposed product profile can include one or more recommended configurations for the integrated software platforms. In some cases, the product profile includes a proposed service or product that may be recommended based on the domain and past platform activity.

The proposed product action can specify one or more recommended actions with respect to the proposed product profile. In some cases, the proposed product action can include a suggested narrative or approach for offering a service or product (e.g., that is identified by the proposed product profile). For example, the proposed product action includes actions related to upgrading current products, adding additional features, suggesting complimentary software products and or services, suggesting other products (e.g., managed by different software platforms), adding capability for increasing number of users, and/or other actions related to suggesting new products/features that are not currently used by a particular user account.

The system and methods include using the recommendation output to determine both which data related to a particular user account to include in a prompt, and to provide instructions configured to guide the generative output engine to provide a generative response that is relevant and customized to a particular user account. For example, content extracted from the recommendation output can be used to construct one or more queries for retrieving data associated with the particular user account. Additionally, content extracted from the recommendation output can provide instructions to the generative output to focus on specific types of products, specific classes of data, specific types of actions (e.g., suggesting new product features) and so on.

In some cases, the recommendation output can be used to construct a first query for obtaining data from an internal database that includes data tracked by an organization providing software services via the multi-platform computing environment. The data stored at the internal database can include tracked data related to particular products, product usage data (e.g., access frequency, products used, features used, and so on), licensing data and/or any other data associated with a particular user account's usage of the software services. Accordingly, the internal database can include tracked product data for multiple user accounts each having access to different subset of products, services, etc. In some cases, the first query can include both a keyword-based search criteria and a semantic-based search criteria. The keyword-based search criteria can be used to obtain results that are related to a particular user account (e.g., specify a particular customer claim identifier received as part of the request). The semantic-based search criteria can be configured to obtain results that are related to the recommendation output (e.g., the proposed product profile and/or the proposed product action).

The recommendation output can be used to construct a second query for obtaining data from a second database that includes data retrieved from third-party sources. For example, the system may obtain publicly available data, such as Form 8K and Form 10K data made available by the Securities and Exchange Commission (SEC) and detailing information about a specific entity that corresponds to a particular user account. In some cases, one or more portions of this data can be obtained by the system and stored in the second database. The obtained data can be processed using suitable methods to help efficient organization, access, and characterization of the data. For example, the obtained data can be vectorized and the second database can store the data as vectorized content. The second query can include generating a search vector using the recommendation output (e.g., the proposed product profile and/or the proposed product action), which can be used to obtain data relevant to a particular user account.

The system and methods can include using the recommendation output and the search results from the query to generate a prompt for submission to a generative output engine. The prompt can include instructions that utilize content from the recommendation output such as a proposed product action and/or a proposed product profile, which can be configured to focus the generative response content on specific products and/or actions identified in the recommendation output. Additionally or alternatively, the prompt can include results from the search queries, which include data that is relevant to the recommendation output. Accordingly, the systems and processes described herein help ensure that the data and instructions provided to a generative output engine include content that is focused on specific product actions and that the data relates to the instructions provided in the prompt.

In some cases, a generative output, received from the generative output engine can be used to generate a natural language proposed message body that is based on tracked data and recommendation outputs that are tailored to a specific customer account. The system can cause display of the natural language proposed message body in a draft of a content item, such as an email, in the email interface displayed on the client device. The client device can be configured to allow for review and/or modification of the natural language proposed message body. The email interface can provide controls for transmitting the content item, including the natural language proposed message body to a recipient associated with the customer account. In some cases, the prompt may include instructions to generate multiple versions of the natural language proposed message body, and a user may be able to select one or more of these versions for transmitting a recipient associated with the customer account. In some cases, the interface displayed on the client device may provide options for regenerating a second natural language proposed message body based on feedback provided by the user. In these cases, the original natural language proposed message body along with inputs from a user may be used to generate a second prompt. The second prompt may include the recommendation output and the search results. Accordingly, the generative output engine can be utilized to create the second natural language message body based on user input to the original/first natural language message body using the same or updated recommendation output and/or obtained search data.

The foregoing embodiments are not exhaustive of the manners by which automatically generated content can be used in multi-platform computing environments, such as those that include more than one collaboration tool (e.g., a content creation system, an issue tracking system, and so on). More generally and broadly, embodiments described herein include systems configured to automatically generate content within environments defined by software platforms. The content can be directly consumed by users of those software platforms or indirectly consumed by users of those software platforms (e.g., formatting of existing content, causing existing systems to perform particular tasks or sequences of tasks, orchestrating complex requests to aggregate information across multiple documents or platforms, and so on) or can integrate two or more software platforms together (e.g., reformatting or recasting user generated content from one platform into a form or format suitable for input to another platform).

### SCALABLE NETWORK ARCHITECTURE FOR AUTOMATIC CONTENT GENERATION

More specifically, systems and methods described herein can leverage a scalable network architecture that includes an input request queue, a normalization (and/or redaction) preconditioning processing pipeline, an optional secondary request queue, and a set of one or more purpose-configured large language model instances (LLMs) and/or other trained classifiers or natural language processors.

Collectively, such engines or natural language processors may be referred to herein as “generative output engines.” A system incorporating a generative output engine can be referred to as a “generative output system” or a “generative output platform.” Broadly, the term “generative output engine” may be used to refer to any combination of computing resources that cooperate to instantiate an instance of software (an “engine”) in turn configured to receive a string prompt as input and configured to provide, as deterministic or pseudo-deterministic output, generated text which may include words, phrases, paragraphs and so on in at least one of (1) one or more human languages, (2) code complying with a particular language syntax, (3) pseudocode conveying in human-readable syntax an algorithmic process, or (4) structured data conforming to a known data storage protocol or format, or combinations thereof.

The string prompt (or “input prompt” or simply “prompt”) received as input by a generative output engine can be any suitably formatted string of characters, in any natural language or text encoding. In some examples, prompts can include non-linguistic content, such as media content (e.g., image attachments, audiovisual attachments, files, links to other content, and so on) or source or pseudocode. In some cases, a prompt can include structured data such as tables, markdown, JSON formatted data, XML formatted data, and the like. A single prompt can include natural language portions, structured data portions, formatted portions, portions with embedded media (e.g., encoded as base64 strings, compressed files, byte streams, or the like) pseudocode portions, or any other suitable combination thereof.

The string prompt may include letters, numbers, whitespace, punctuation, and in some cases formatting. Similarly, the generative output of a generative output engine as described herein can be formatted/encoded according to any suitable encoding (e.g., ISO, Unicode, ASCII as examples). In these embodiments, a user may provide input to a software platform coupled to a network architecture as described herein. The user input may be in the form of interaction with a graphical user interface affordance (e.g., button or other UI element), or may be in the form of plain text. In some cases, the user input may be provided as typed string input provided to a command prompt triggered by a preceding user input.

For example, the user may engage with a button in a UI that causes a command prompt input box to be rendered, into which the user can begin typing a command. In other cases, the user may position a cursor within an editable text field and the user may type a character or trigger sequence of characters that cause a command-receptive user interface element to be rendered. As one example, a text editor may support slash commands-after the user types a slash character, any text input after the slash character can be considered as a command to instruct the underlying system to perform a task.

Regardless of how a software platform user interface is instrumented to receive user input, the user may provide an input that includes a string of text including a natural language request or instruction (e.g., a prompt). The prompt may be provided as input to an input queue including other requests from other users or other software platforms. Once the prompt is popped from the queue, it may be normalized and/or preconditioned by a preconditioning service.

The preconditioning service can, without limitation: append additional context to the user's raw input; may insert the user's raw input into a template prompt selected from a set of prompts; replace ambiguous references in the user's input with specific references (e.g., replace user-directed pronouns with user IDs, replace @mentions with user IDs, and so on); correct spelling or grammar; translate the user input to another language; or other operations. Thereafter, optionally, the modified/supplemented/hydrated user input can be provided as input to a secondary queue that meters and orders requests from one or more software platforms to a generative output system, such as described herein. The generative output system receives, as input, a modified prompt and provides a continuation of that prompt as output which can be directed to an appropriate recipient, such as the graphical user interface operated by the user that initiated the request or such as a separate platform. Many configurations and constructions are possible.

### LARGE LANGUAGE MODELS

An example of a generative output engine of a generative output system as described herein may be a large language model (LLM). Generally, an LLM is a neural network specifically trained to determine probabilistic relationships between members of a sequence of lexical elements, characters, strings or tags (e.g., words, parts of speech, or other subparts of a string), the sequence presumed to conform to rules and structure of one or more natural languages and/or the syntax, convention, and structure of a particular programming language and/or the rules or convention of a data structuring format (e.g., JSON, XML, HTML, Markdown, and the like).

More simply, an LLM is configured to determine what word, phrase, number, whitespace, nonalphanumeric character, or punctuation is most statistically likely to be next in a sequence, given the context of the sequence itself. The sequence may be initialized by the input prompt provided to the LLM. In this manner, output of an LLM is a continuation of the sequence of words, characters, numbers, whitespace, and formatting provided as the prompt input to the LLM.

To determine probabilistic relationships between different lexical elements (as used herein, “lexical elements” may be a collective noun phase referencing words, characters, numbers, whitespace, formatting, and the like), an LLM is trained against as large of a body of text as possible, comparing the frequency with which particular words appear within N distance of one another. The distance N may be referred to in some examples as the token depth or contextual depth of the LLM.

In many cases, word and phrase lexical elements may be lemmatized, part of speech tagged, or tokenized in another manner as a pretraining normalization step, but this is not required of all embodiments. Generally, an LLM may be trained on natural language text in respect of multiple domains, subjects, contexts, and so on; typical commercial LLMs are trained against substantially all available internet text or written content available (e.g., printed publications, source repositories, and the like). Training data may occupy petabytes of storage space in some examples.

As an LLM is trained to determine which lexical elements are most likely to follow a preceding lexical element or set of lexical elements, an LLM must be provided with a prompt that invites continuation. In general, the more specific a prompt is, the fewer possible continuations of the prompt exist. For example, the grammatically incomplete prompt of “can a computer” invites completion, but also represents an initial phrase that can begin a near limitless number of probabilistically reasonable next words, phrases, punctuation, and whitespace. A generative output engine may not provide a contextually interesting or useful response to such an input prompt, effectively choosing a continuation at random from a set of generated continuations of the grammatically incomplete prompt.

By contrast, a narrower prompt that invites continuation may be “can a computer supplied with a 30 W power supply consume 60 W of power?” A large number of possible correct phrasings of a continuation of this example prompt exist, but the number is significantly smaller than the preceding example, and a suitable continuation may be selected or generated using a number of techniques. In many cases, a continuation of an input prompt may be referred to more generally as “generated text” or “generated output” provided by a generative output engine as described herein.

Generally, many written natural languages, syntaxes, and well-defined data structuring formats can be probabilistically modeled by an LLM trained by a suitable training dataset that is both sufficiently large and sufficiently relevant to the language, syntax, or data structuring format desired for automatic content/output generation.

In addition, because punctuation and whitespace can serve as a portion of training data, generated output of an LLM can be expected to be grammatically and syntactically correct, as well as being punctuated appropriately. As a result, generated output can take many suitable forms and styles, if appropriate in respect of an input prompt.

Further, as noted above in addition to natural language, LLMs can be trained on source code in various highly structured languages or programming environments and/or on data sets that are structured in compliance with a particular data structuring format (e.g., markdown, table data, CSV data, TSV data, XML, HTML, JSON, and so on).

As with natural language, data structuring and serialization formats (e.g., JSON, XML, and so on) and high-order programming languages (e.g., C, C++, Python, Go, Ruby, JavaScript, Swift, and so on) include specific lexical rules, punctuation conventions, whitespace placement, and so on. In view of this similarity with natural language, an LLM generated output can, in response to suitable prompts, include source code in a language indicated or implied by that prompt.

For example, a prompt of “what is the syntax for a while loop in C and how does it work” may be continued by an LLM by providing, in addition to an explanation in natural language, a C++ compliant example of a while loop pattern. In some cases, the continuation/generative output may include format tags/keys such that when the output is rendered in a user interface, the example C++ code that forms a part of the response is presented with appropriate syntax highlighting and formatting.

As noted above, in addition to source code, generative output of an LLM or other generative output engine type can include and/or may be used for document structuring or data structuring, such as by inserting format tags (e.g., markdown). In other cases, whitespace may be inserted, such as paragraph breaks, page breaks, or section breaks. In yet other examples, a single document may be segmented into multiple documents to support improved legibility. In other cases, an LLM generated output may insert cross-links to other content, such as other documents, other software platforms, or external resources such as websites.

In yet further examples, an LLM generated output can convert static content to dynamic content. In one example, a user-generated document can include a string that contextually references another software platform. For example, a documentation platform document may include the string “this document corresponds to project ID 123456, status of which is pending.” In this example, a suitable LLM prompt may be provided that causes the LLM to determine an association between the documentation platform and a project management platform based on the reference to “project ID 123456.”

In response to this recognized context, the LLM can wrap the substring “project ID 123456” in anchor tags with an embedded URL in HTML-compliant syntax that links directly to project 123456 in the project management platform, such as: “<a href=‘https://example link/123456>project 123456</a>”.

In addition, the LLM may be configured to replace the substring “pending” with a real-time updating token associated with an API call to the project management system. In this manner, the LLM converts a static string within the document management system into richer content that facilitates convenient and automatic cross-linking between software products, which may result in additional downstream positive effects on performance of indexing and search systems.

In further embodiments, the LLM may be configured to generate as a portion of the same generated output a body of an API call to the project management system that creates a link back or other association to the documentation platform. In this manner, the LLM facilities bidirectional content enrichment by adding links to each software platform.

More generally, a continuation produced as output by an LLM can include not only text, source code, pseudocode, structured data, and/or cross-links to other platforms, but it also may be formatted in a manner that includes titles, emphasis, paragraph breaks, section breaks, code sections, quote sections, cross-links to external resources, inline images, graphics, table-backed graphics, and so on.

In yet further examples, static data may be generated and/or formatted in a particular manner in a generative output. For example, a valid generative output can include JSON-formatted data, XML-formatted data, HTML-formatted data, markdown table formatted data, comma-separated value data, tab-separated value data, or any other suitable data structuring defined by a data serialization format.

### TRANSFORMER ARCHITECTURE

In many constructions, an LLM may be implemented with a transformer architecture. In other cases, traditional encoder/decoder models may be appropriate. In transformer topologies, a suitable self-attention or intra-attention mechanism may be used to inform both training and generative output. A number of different attention mechanisms, including self-attention mechanisms, may be suitable.

In sum, in response to an input prompt that at least contextually invites continuation, a transformer-architected LLM may provide probabilistic, generated, output informed by one or more self-attention signals. Even still, the LLM or a system coupled to an output thereof may be required to select one of many possible generated outputs/continuations.

In some cases, continuations may be misaligned in respect of conventional ethics. For example, a continuation of a prompt requesting information to build a weapon may be inappropriate. Similarly, a continuation of a prompt requesting to write code that exploits a vulnerability in software may be inappropriate. Similarly, a continuation requesting drafting of libelous content in respect of a real person may be inappropriate. In more innocuous cases, continuations of an LLM may adopt an inappropriate tone or may include offensive language.

In view of the foregoing, more generally, a trained LLM may provide output that continues an input prompt, but in some cases, that output may be inappropriate. To account for these and other limitations of source-agnostic trained LLMs, fine tuning may be performed to align output of the LLM with values and standards appropriate to a particular use case. In many cases, reinforcement training may be used. In particular, output of an untuned LLM can be provided to a human reviewer for evaluation.

The human reviewer can provide feedback to inform further training of the LLM, such as by filling out a brief survey indicating whether a particular generated output: suitably continues the input prompt; contains offensive language or tone; provides a continuation misaligned with typical human values; and so on.

This reinforcement training by human feedback can reinforce high quality, tone neutral, continuations provided by the LLM (e.g., positive feedback corresponds to positive reward) while simultaneously disincentivizing the LLM to produce offensive continuations (e.g., negative feedback corresponds to negative reward). In this manner, an LLM can be fine-tuned to preferentially produce desirable, inoffensive, generative output which, as noted above, can be in the form of natural language and/or source code.

### GENERATIVE OUTPUT ENGINES & GENERATIVE OUTPUT SYSTEMS

Independent of training and/or configuration of one or more underlying engines (typically instantiated as software), it may be appreciated that generally and broadly, a generative output system as described herein can include a physical processor or an allocation of the capacity thereof (shared with other processes, such as operating system processes and the like), a physical memory or an allocation thereof, and a network interface. The physical memory can include datastores, working memory portions, storage portions, and the like. Storage portions of the memory can include executable instructions that, when executed by the processor, cause the processor to (with assistance of working memory) instantiate an instance of a generative output application, also referred to herein as a generative output service.

The generative output application can be configured to expose one or more API endpoint, such as for configuration or for receiving input prompts. The generative output application can be further configured to provide generated text output to one or more subscribers or API clients. Many suitable interfaces can be configured to provide input to and to receive output from a generative output application, as described herein.

For simplicity of description, the embodiments that follow reference generative output engines and generative output applications configured to exchange structured data with one or more clients, such as the input and output queues described above. The structured data can be formatted according to any suitable format, such as JSON or XML. The structured data can include attributes or key-value pairs that identify or correspond to subparts of a single response from the generative output engine.

For example, a request to the generative output engine from a client can include attribute fields such as, but not limited to: requester client ID; requester authentication tokens or other credentials; requester authorization tokens or other credentials; requester username; requester tenant ID or credentials; API key(s) for access to the generative output engine; request timestamp; generative output generation time; request prompt; string format form generated output; response types requested (e.g., paragraph, numeric, or the like); callback functions or addresses; generative engine ID; data fields; supplemental content; reference corpuses (e.g., additional training or contextual information/data) and so on. A simple example request may be JSON formatted, and may be:

```
{
    “prompt” : “Generate five words of placeholder text in the
English language.”,
  “API_KEY: “hx-Y5u4zx3kaF67AzkXK1hC”,
    “user_token”: “PkcLe7Co2G-50AoIVojGJ”
}
```

Similarly, a response from the generative output engine can include attribute fields such as, but not limited to: requester client ID; requester authentication tokens or other credentials; requester authorization tokens or other credentials; requester username; requester role; request timestamp; generative output generation time; request prompt; generative output formatted as a string; and so on. For example, a simple response to the preceding request may be JSON formatted and may be:

```
{
  “response” : “Hello world text goes here.”,
  “generation_time_ms” : 2
}
```

In some embodiments, a prompt provided as input to a generative output engine can be engineered from user input. For example, in some cases, a user input can be inserted into an engineered template prompt that itself is stored in a database. For example, an engineered prompt template can include one or more fields into which user input portions thereof can be inserted. In some cases, an engineered prompt template can include contextual information that narrows the scope of the prompt, increasing the specificity thereof.

For example, some engineered prompt templates can include example input/output format cues or requests that define for a generative output engine, as described herein, how an input format is structured and/or how output should be provided by the generative output engine.

### PROMPT PRE-CONFIGURATION, TEMPLATIZING, & ENGINEERING

As noted above, a prompt received from a user can be preconditioned and/or parsed to extract certain content therefrom. The extracted content can be used to inform selection of a particular engineered prompt template from a database of engineered prompt templates. Once the selected prompt template is selected, the extracted content can be inserted into the template to generate a populated engineered prompt template that, in turn, can be provided as input to a generative output engine as described herein.

In many cases, a particular engineered prompt template can be selected based on a desired task for which output of the generative output engine may be useful to assist. For example, if a user requires a summary of a particular document, the user input prompt may be a text string comprising the phrase “generate a summary of this page.” A software instance configured for prompt preconditioning—which may be referred to as a “preconditioning software instance” or “prompt preconditioning software instance”—may perform one or more substitutions of terms or words in this input phrase, such as replacing the demonstrative pronoun phrase “this page” with an unambiguous unique page ID. In this example, preconditioning software instance can provide an output of “generate a summary of the page with id 123456” which in turn can be provided as input to a generative output engine.

In an extension of this example, the preconditioning software instance can be further configured to insert one or more additional contextual terms or phrases into the user input. In some cases, the inserted content can be inserted at a grammatically appropriate location within the input phrase or, in other cases, may be appended or prepended as separate sentences. For example, in an embodiment, the preconditioning software instance can insert a phrase that adds contextual information describing the user making the initial input and request. In this example, output of the prompt preconditioning instance may be “generate a summary of the page with id 123456 with phrasing and detail appropriate for the role of user 76543.” In this example, if the user requesting the summary is an engineer, a different summary may be provided than if the user requesting the summary is a manager or executive.

In yet other examples, prompt preconditioning may be further contextualized before a given prompt is provided as input to a generative output engine. Additional information that can be added to a prompt (sometimes referred to as “contextual information” or “prompt context” or “supplemental prompt information”) can include but may not be limited to: user names; user roles; user tenure (e.g., new users may benefit from more detailed summaries or other generative content than long-term users); user projects; user groups; user teams; user tasks; user reports; tasks, assignments, or projects of a user's reports, and so on.

For example, in some embodiments, a user-input prompt may be “generate a table of all my tasks for the next two weeks, and insert the table into my home page in my personal space.” In this example, a preconditioning instance can replace “my” with a reference to the user's ID or another unambiguous identifier associated with the user. Similarly, the “home page in my personal space” can be replaced, contextually, with a page identifier that corresponds to that user's personal space and the page that serves as the homepage thereof. Additionally, the preconditioning instance can replace the referenced time window in the raw input prompt based on the current date and based on a calculated date two weeks in the future. With these two modifications, the modified input prompt may “generate a table of the tasks assigned to User 1234 dating from Jan. 1, 2023-Jan. 14, 2023 (inclusive), and insert the generated table into page 567.” In these embodiments, the preconditioning instance may be configured to access session information to determine the user ID.

In other cases, the preconditioning service may be configured to structure and submit a query to an active directory service or user graph service to determine user information and/or relationships to other users. For example, a prompt of “summarize the edits to this page made by my team since I last visited this page” could determine the user's ID, team members with close connections to that user based on a user graph, determine that the user last visited the page three weeks prior, and filter attribution of edits within the last three weeks to the current page ID based on those team members. With these modifications, the prompt provided to the generative output engine may be:

```
{
  “raw_prompt” : summarize the edits to this page made by
my team since I last visited this page”,
  “modified_prompt” : “Generate a summary of each
paragraph tagged with an editId attribute matching editId=1,
editId=51, editId=165, editId=99 within the following HTML-
formatted content: [HTML-formatted content of the page].”
}
```

Similarly, the preconditioning service may utilize a project graph, issue graph, or other data structure that is generated using edges or relationships between system objects that are determined based on express object dependencies, user event histories of interactions with related objects, or other system activity indicating relationships between system objects. The graphs may also associate system objects with particular users or user identifiers based on interaction logs or event histories.

Generally, a preconditioning service, as described herein, can be configured to access and append significant contextual information describing a user and/or users associated with the user submitting a particular request, the user's role in a particular organization, the user's technical expertise, the user's computing hardware (e.g., different response formats may be suitable and/or selectable based on user equipment), and so on.

In further implementations of this example, a snippet of prompt text can be selected from a snippet dictionary or table that further defines how the requested table should be formatted as output by the generative output engine. For example, a snippet selected from a database and appended to the modified prompt may be:

{
“snippet123_table_from_tasks” : “The table should be
formatted as a three-column table with multiple rows. The leftmost
column should be titled ‘Title’ and the corresponding content of each
row of this column should be the title attribute of a task. The middle
column should be titled ‘Created Date’ and the corresponding
content of each row of this column should be the creation date of the
task. The rightmost column should be titled ‘Status’ and the
corresponding content of each row of this column should be the
status attribute of the selected task.”
}

The foregoing examples of modifications and supplements to user input prompt are not exhaustive. Other modifications are possible. In one embodiment, the user input of “generate a table of all my tasks for the next two weeks” may be converted, supplemented, modified, and/or otherwise preconditioned to:

{
“modified_prompt” : “Find all tasks assigned to User 1234
dating from Jan 01, 2023 - Jan 14, 2023 (inclusive). Create a table
in which each found task corresponds to a respective row of that
table. The table should be formatted as a markdown table, in plain
text, with three columns. The leftmost column should be titled ‘Title’
and the corresponding content of each row of this column should be
the title attribute of a respective task. The middle column should be
titled ‘Created Date’ and the corresponding content of each row of
this column should be the creation date of the respective task. The
rightmost column should be titled ‘Status’ and the corresponding
content of each row of this column should be the status attribute of
the respective task.”
}

The operations of modifying a user input into a descriptive paragraph or set of paragraphs that further contextualize the input may be referred to as “prompt engineering.” In many embodiments, a preconditioning software instance may serve as a portion of a prompt engineering service configured to receive user input and to enrich, supplement, and/or otherwise hydrate a raw user input into a detailed prompt that may be provided as input to a generative output engine as described herein.

In other embodiments, a prompt engineering service may be configured to append bulk text to a prompt, such as document content in need of summarization or contextualization.

In other cases, a prompt engineering service can be configured to recursively and/or iteratively leverage output from a generative output engine in a chain of prompts and responses. For example, a prompt may call for a summary of all documents related to a particular project. In this case, a prompt engineering service may coordinate and/or orchestrate several requests to a generative output engine to summarize a first document, a second document, and a third document, and then generate an aggregate response of each of the three summarized documents. In yet other examples, staging of requests may be useful for other purposes.

### AUTHENTICATION & AUTHORIZATION

Still further embodiments reference systems and methods for maintaining compliance with permissions, authentication, and authorization within a software environment. For example, in some embodiments, a prompt engineering service can be configured to append to a prompt one or more contextualizing phrases that direct a generative output engine to draw insight from only a particular subset of content to which the requesting user has authorization to access.

In other cases, a prompt engineering service may be configured to proactively determine what data or database calls may be required by a particular user input. If data required to service the user's request is not authorized to be accessed by the user, that data and/or references to it may be restricted/redacted/removed from the prompt before the prompt is submitted as input to a generative output engine. The prompt engineering service may access a user profile of the respective user and identify content having access permissions that are consistent with a role, permissions profile, or other aspect of the user profile.

In other embodiments, a prompt engineering service may be configured to request that the generative output engine append citations (e.g., back links) to each page or source from which information in a generative response was based. In these examples, the prompt engineering service or another software instance can be configured to iterate through each link to determine (1) whether the link is valid, and (2) whether the requesting user has permission and authorization to view content at the link. If either test fails, the response from the generative output engine may be rejected and/or a new prompt may be generated specifically including an exclusion request such as “Exclude and ignore all content at XYZ.url.”

In yet other examples, a prompt engineering service may be configured to classify a user input into one of a number of classes of request. Different classes of request may be associated with different permissions handling techniques. For example, a class of request that requires a generative output engine to resource from multiple pages may have different authorization enforcement mechanisms or workflows than a class of request that requires a generative output engine to resource from only a single location.

These foregoing examples are not exhaustive. Many suitable techniques for managing permissions in a prompt engineering service and generative output engine system may be possible in view of the embodiments described herein.

More generally, as noted above, a generative output engine may be a portion of a larger network and communications architecture as described herein. This network can include input queues, prompt constructors, engine selection logical elements, request routing appliances, authentication handlers and so on.

### COLLABORATION PLATFORMS INTEGRATED WITH GENERATIVE OUTPUT SYSTEMS

In particular, embodiments described herein are focused to leveraging generative output engines to produce content in a software platform used for collaboration between multiple users, such as documentation tools, issue tracking systems, project management systems, information technology service management systems, ticketing systems, repository systems, telecommunications systems, messaging systems, and the like, each of which may define different environments in which content can be generated by users of those systems. These types of platforms may be generally referred to herein as “collaboration platforms” or “content collaboration platforms.”

In one example, a documentation system may define an environment in which users of the documentation system can leverage a user interface of a frontend of the system to generate documentation in respect of a project, product, process, or goal. For example, a software development team may use a documentation system to document features and functionality of the software product. In other cases, the development team may use the documentation system to capture meeting notes, track project goals, and outline internal best practices.

Other software platforms store, collect, and present different information in different ways. For example, an issue tracking system may be used to assign work within an organization and/or to track completion of work, a ticketing system may be used to track compliance with service level agreements, and so on. Any one of these software platforms or platform types can be communicably coupled to a generative output engine, as described herein, in order to automatically generate structured or unstructured content within environments defined by those systems.

In some implementations, a content collaboration system may include a documentation system, also referred to herein as a documentation platform, which can leverage a generative output engine to provide a generative answer interface to provide synthesized or generated responses leveraging content items hosted by the system. The documentation system may also leverage a generative output engine to provide, without limitation: summarize individual documents; summarize portions of documents; summarize multiple selected documents; generate document templates; generate document section templates; generate suggestions for cross-links to other documents or platforms; generate suggestions for adding detail or improving conciseness for particular document sections; and so on. As described with respect to examples provided herein, a documentation system can store user-generated content in electronic documents or electronic pages, also referred to herein simply as documents or pages. The documents or pages may include a variety of user-generated content including text, images, video, and links to content provided by other platforms. The documentation system may also save user interaction events including user edit action, content viewing actions, commenting, content sharing, and other user interactions. The document content in addition to select user interaction events may be indexed and searchable by the system. In some examples, the documentation system may organize documents or pages into a document space, which defines a hierarchical relationship between the pages and documents and also defines a permissions profile or scheme for the documents or pages of the space.

In some implementations, a content collaboration system may include an issue tracking system or task management system (also referred to herein as issue tracking platforms or issue management platforms). The issue tracking system may also leverage a generative output engine to provide a generative answer interface to provide synthesized or generated responses leveraging content items (e.g., issues or tasks) hosted by the system. The issue tracking system may also leverage a generative output engine to provide, without limitation: summarize issues; summarize portions of issues or fields of issues; summarize multiple selected issues, tasks, or events; generate issue templates; and so on. As described with respect to examples provided herein, an issue tracking system can manage various issues or tasks that are processed in accordance with an automated workflow. The workflow may define a series of states that the issue or task must traverse before being completed. The system may also track user interaction events, issue state transitions, and other events that occur over the lifecycle of the issue, which may be indexed and searchable by the system.

More broadly, it may be appreciated that a single organization may be a tenant of multiple software platforms, of different software platform types. Generally and broadly, regardless of configuration or purpose, a software platform that can serve as source information for operation of a generative output engine as described herein may include a frontend and a backend configured to communicably couple over a computing network (which may include the open Internet) to exchange computer-readable structured data.

The frontend may be a first instance of software executing on a client device, such as a desktop computer, laptop computer, tablet computer, or handheld computer (e.g., mobile phone). The backend may be a second instance of software executing over a processor allocation and memory allocation of a virtual or physical computer architecture. In many cases, although not required, the backend may support multiple tenancies. In such examples, a software platform may be referred to as a multi-tenant software platform.

For simplicity of description, the multi-tenant embodiments presented herein reference software platforms from the perspective of a single common tenant. For example, an organization may secure a tenancy of multiple discrete software platforms, providing access for one or more employees to each of the software platforms. Although other organizations may have also secured tenancies of the same software platforms which may instantiate one or more backends that serve multiple tenants, it is appreciated that data of each organization is siloed, encrypted, and inaccessible to, other tenants of the same platform.

In many embodiments, the frontend and backend of a software platform—multi-tenant or otherwise—as described herein are not collocated, and communicate over a large area and/or wide area network by leveraging one or more networking protocols, but this is not required of all implementations.

A frontend of a software platform, also referred to as a frontend or client application, may be configured to render a graphical user interface at a client device that instantiates frontend software. As a result of this architecture, the graphical user interface of the frontend can receive inputs from a user of the client device, which, in turn, can be formatted by the frontend into computer-readable structured data suitable for transmission to the backend for storage, transformation, and later retrieval. One example architecture includes a graphical user interface rendered in a browser executing on the client device. In other cases, a frontend may be a native application executing on a client device. Regardless of architecture, it may be appreciated that generally and broadly a frontend of a software platform as described herein is configured to render a graphical user interface to receive inputs from a user of the software platform and to provide outputs to the user of the software platform.

Input to a frontend of a software platform by a user of a client device within an organization may be referred to herein as “organization-owned” content. With respect to a particular software platform, such input may be referred to as “tenant-owned” or “platform-specific” content. In this manner, a single organization's owned content can include multiple buckets of platform-specific content.

Herein, the phrases “tenant-owned content” and “platform-specific content” may be used to refer to any and all content, data, metadata, or other information regardless of form or format that is authored, developed, created, or otherwise added by, edited by, or otherwise provided for the benefit of, a user or tenant of a multi-tenant software platform. In many embodiments, as noted above, tenant-owned content may be stored, transmitted, and/or formatted for display by a frontend of a software platform as structured data. In particular structured data that includes tenant-owned content may be referred to herein as a “data object” or a “tenant-specific data object.”

In a more simple, non-limiting phrasing, any software platform described herein can be configured to store one or more data objects in any form or format unique to that platform. Any data object of any platform may include one or more attributes and/or properties or individual data items that, in turn, include tenant-owned content input by a user.

Example tenant-owned content can include personal data, private data, health information, personally-identifying information, business information, trade secret content, copyrighted content or information, restricted access information, research and development information, classified information, mutually-owned information (e.g., with a third party or government entity), or any other information, multi-media, or data. In many examples, although not required, tenant-owned content or, more generally, organization-owned content may include information that is classified in some manner, according to some procedure, protocol, or jurisdiction-specific regulation.

In particular, the embodiments and architectures described herein can be leveraged by a provider of multi-tenant software and, in particular, by a provider of suites of multi-tenant software platforms, each platform being configured for a different particular purpose. Herein, providers of systems or suites of multi-tenant software platforms are referred to as “multiplatform service providers.”

In general, customers/clients of a multiplatform service provider are typically tenants of multiple platforms provided by a given multiplatform service provider. For example, a single organization (a client of a multiplatform service provider) may be a tenant of a messaging platform and, separately, a tenant of a project management platform.

The organization can create and/or purchase user accounts for its employees so that each employee has access to both messaging and project management functionality. In some cases, the organization may limit seats in each tenancy of each platform so that only certain users have access to messaging functionality and only certain users have access to project management functionality; the organization can exercise discretion as to which users have access to either or both tenancies.

In another example, a multiplatform service provider can host a suite of collaboration tools. For example, a multiplatform service provider may host, for its clients, a multi-tenant issue tracking system, a multi-tenant code repository service, and a multi-tenant documentation service. In this example, an organization that is a customer/client of the service provider may be a tenant of each of the issue tracking system or platform, a code repository system or platform (also referred to as a source-code management system or platform), and/or a documentation system or platform.

As with preceding examples, the organization can create and/or purchase user accounts for its employees, so that certain selected employees have access to one or more of issue tracking functionality, documentation functionality, and code repository functionality.

In this example and others, it may be possible to leverage multiple collaboration platforms to advance individual projects or goals. For example, for a single software development project, a software development team may use (1) a code repository to store project code, executables, and/or static assets, (2) a documentation platform to maintain documentation related to the software development project, (3) an issue tracking platform to track assignment and progression of work, and (4) a messaging service or platform to exchange information directly between team members. However, as organizations grow, as project teams become larger, and/or as software platforms mature and add features or adjust user interaction paradigms over time, using multiple software platforms can become inefficient for both individuals and organizations. Further, as described herein, it can be difficult to locate content or answer queries in a multiplatform system having diverse content and data structures used to provide the various content items. As described herein, a generative answer interface may be adapted to access multi-platform content and provide generative responses that bridge various content item types and platform structures.

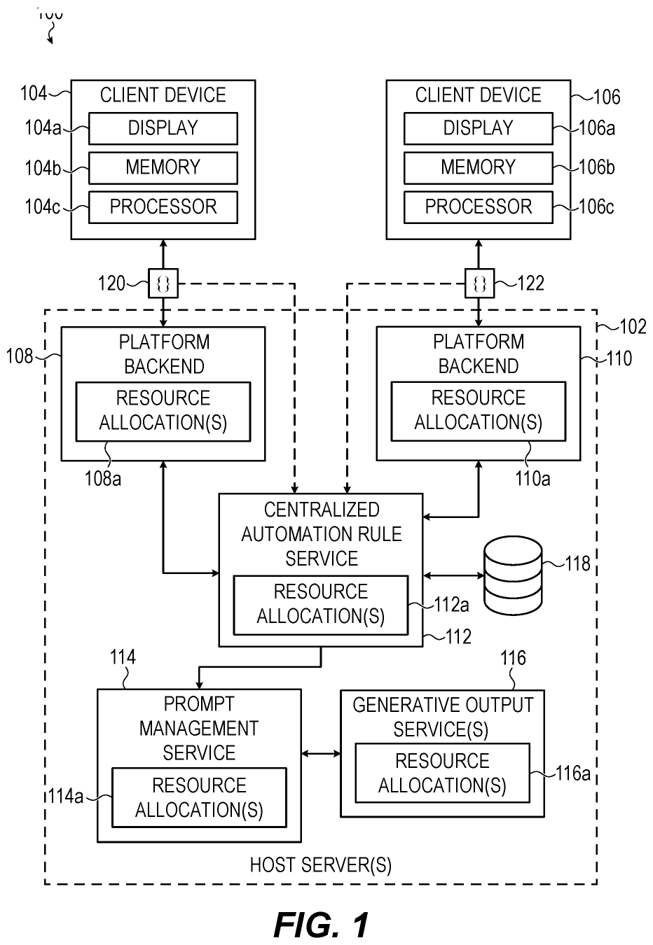

These foregoing and other embodiments are discussed below with reference to FIGS. 1-8. The detailed description given herein with respect to these figures is for explanation only and should not be construed as limiting.

### USER INPUT RESULTING IN GENERATIVE OUTPUT

FIG. 1 depicts a simplified diagram of a system, such as described herein that can include and/or may receive input from a generative output engine as described herein. The system 100 is depicted as implemented in a client-server architecture, but it may be appreciated that this is merely one example and that other communications architectures are possible.

In particular the system 100 includes a set of host servers 102 which may be one or more virtual or physical computing resources (collectively referred in many cases as a “cloud platform”). In some cases, the set of host servers 102 can be physically collocated or in other cases, each may be positioned in a geographically unique location. The set of host servers 102 can be communicably coupled to one or more client devices; two example devices are shown as the client device 104 and the client device 106. The client devices 104, 106 can be implemented as any suitable electronic device. In many embodiments, the client devices 104, 106 are personal computing devices such as desktop computers, laptop computers, or mobile phones.

The set of host servers 102 can be supporting infrastructure for one or more backend applications, each of which may be associated with a particular software platform, such as a documentation platform or an issue tracking platform. Other examples include ITSM systems, chat platforms, messaging platforms, and the like. These backends can be communicably coupled to a generative output engine that can be leveraged to provide unique intelligent functionality to each respective backend. For example, the generative output engine can be configured to receive user prompts, such as described above, to modify, create, or otherwise perform operations against content stored by each respective software platform.

By centralizing access to the generative output engine in this manner, the generative output platform can also serve as an integration between multiple platforms. For example, one platform may be a documentation platform and the other platform may be an issue tracking system. In these examples, a user of the documentation platform may input a prompt requesting a summary of the status of a particular project documented in a particular page of the documentation platform. A comprehensive continuation/response to this summary request may pull data or information from the issue tracking system as well.

A user of the client devices may trigger production of generative output in a number of suitable ways. One example is shown in FIG. 1. In particular, in this embodiment, each of the software platforms can share a common feature, such as a common centralized editor rendered in a frame of the frontend user interfaces of both platforms.

Turning to FIG. 1, a portion of the set of host servers 102 can be allocated as physical infrastructure supporting a first platform backend 108 and a different portion of the set of host servers 102 can be allocated as physical infrastructure supporting a second platform backend 110.

The two different platforms may be instantiated over physical resources provided by the set of host servers 102. Once instantiated, the first platform backend 108 and the second platform backend 110 can each communicably couple to a centralized content service 112. The centralized content service may be a search interface, generative content service or, in some cases, a centralized editing service which may also referred to more simply as an “editor” or an “editor service.”

In implementations in which the centralized content service 112 is a search interface or generative content service, the service 112 may be instantiated or implemented in response to a user input provided to a frontend application in communication with one of the platform backends 108, 110. The service 112 may be configured to leverage authenticated user sessions between multiple platforms in order to access content and provide aggregated or composite results to the user. The service 112 may be instantiated as a plugin to the respective frontend application, may be integrated with the frontend application or, in some implementations, may be instantiated as a separate and distinct service or application instance.

In implementations in which this centralized content service 112 is an editing service, the centralized content service 112 may be referred to as a centralized content editing frame service 112. The centralized content editing frame service 112 can be configured to cause rendering of a frame within respective frontends of each of the first platform backend 108 and the second platform backend 110. In this manner, and as a result of this construction, each of the first platform and the second platform present a consistent user content editing experience.

More specifically, the centralized content editing frame service 112 may be a rich text editor with added functionality (e.g., slash command interpretation, in-line images and media, and so on). As a result of this centralized architecture, multiple platforms in a multiplatform environment can leverage the features of the same rich text editor. This provides a consistent experience to users while dramatically simplifying processes of adding features to the editor.

For example, in one embodiment, a user in a multiplatform environment may use and operate a documentation platform and an issue tracking platform. In this example, both the issue tracking platform and the documentation platform may be associated with a respective frontend and a respective backend. Each platform may be additionally communicably and/or operably coupled to a centralized content service 112 that can be called by each respective frontend whenever it is required to present the user of that respective frontend with an interface to edit text.

For example, the documentation platform's frontend may call upon the centralized content service 112 to render, or assist with rendering, a user input interface element to receive user text input in a generative interface of a documentation platform. Similarly, the issue tracking platform's frontend may call upon the centralized content service 112 to render, or assist with rendering, a user input interface element to receive user text input or other input in a generative interface. In these examples, the centralized content service 112 can parse text input provided by users of the documentation platform frontend and/or the issue tracking platform backend, monitoring for command and control keywords, phrases, trigger characters, and so on. In many cases, for example, the centralized content service 112 can implement a slash command service that can be used by a user of either platform frontend to issue commands to the backend of the other system. As described herein, the centralized content service 112 may cause display of a generative answer interface having input regions and controls that can be used to receive user input and provide commands to the system.

In one example, the user of the documentation platform frontend can input a slash command to the content editing frame, rendered in the documentation platform frontend supported by the centralized content service 112, in order to type a prompt including an instruction to create a new issue or a set of new issues in the issue tracking platform. Similarly, the user of the issue tracking platform can leverage slash command syntax, enabled by the centralized content service 112, to create a prompt that includes an instruction to edit, create, or delete a document stored by the documentation platform.

As described herein, a “content editing frame” references a user interface element that can be leveraged by a user to draft and/or modify rich content including, but not limited to: formatted text; image editing; data tabling and charting; file viewing; and so on. These examples are not exhaustive; the content editing elements can include and/or may be implemented to include many features, which may vary from embodiment to embodiment. For simplicity of description the embodiments that follow reference a centralized content service 112 configured for rich text editing, but it may be appreciated that this is merely one example.

As a result of architectures described herein, developers of software platforms that would otherwise dedicate resources to developing, maintaining, and supporting content editing features can dedicate more resources to developing other platform-differentiating features, without needing to allocate resources to development of software components that are already implemented in other platforms.

In addition, as a result of the architectures described herein, services supporting the centralized content service 112 can be extended to include additional features and functionality—such as a user input field, selectable control, a slash command processor, or other user interface element—which, in turn, can automatically be leveraged by any further platform that incorporates a generative interface, and/or otherwise integrates with the centralized content service 112 itself. In this example, commands or input facilitated by the generative service can be used to receive prompt instructions from users of either frontend. These prompts can be provided as input to a prompt engineering/prompt preconditioning service (such as the prompt management service 114) that, in turn, provides a modified user prompt as input to a generative engine service 116.

The generative output engine service may be hosted over the host servers 102 or, in other cases, may be a software instance instantiated over separate hardware. In some cases, the generative engine service may be a third-party service that serves an API interface to which one or more of the host services and/or preconditioning service can communicably couple.

The generative output engine can be configured as described above to provide any suitable output, in any suitable form or format. Examples include content to be added to user-generated content, API request bodies, replacing user-generated content, and so on.

In addition, a centralized content service 112 can be configured to provide suggested prompts to a user as the user types. For example, as a user begins typing a slash command in a frontend of some platform that has integrated with a centralized content service 112 as described herein, the centralized content service 112 can monitor the user's typing to provide one or more suggestions of prompts, commands, or controls (herein, simply “preconfigured prompts”) that may be useful to the particular user providing the text input. The suggested preconfigured prompts may be retrieved from a database 118. In some cases, each of the preconfigured prompts can include fields that can be replaced with user-specific content, whether generated in respect of the user's input or generated in respect of the user's identity and session.

In some embodiments, the centralized content service 112 can be configured to suggest one or more prompts that can be provided as input to a generative output engine as described herein to perform a useful task, such as summarizing content rendered within the centralized content service 112, reformatting content rendered within the centralized content service 112, inserting cross-links within the centralized content service 112, and so on.

The ordering of the suggestion list and/or the content of the suggestion list may vary from user to user, user role to user role, and embodiment to embodiment. For example, when interacting with a documentation system, a user having a role of “developer” may be presented with prompts, content, or functionality associated with tasks related to an issue tracking system and/or a code repository system. Alternatively, when interacting with the same documentation system, a user having a role of “human resources professional” may be presented with prompts, content, or functionality associated with manipulating or summarizing information presented in a directory system or a benefits system, instead of the issue tracking system or the code repository system.

More generally, in some embodiments described herein, a centralized content service 112 can be configured to suggest to a user one or more prompts that can cause a generative output engine to provide useful output and/or perform a useful task for the user. These suggestions/prompts can be based on the user's role, a user interaction history by the same user, user interaction history of the user's colleagues, or any other suitable filtering/selection criteria.

In addition to the foregoing, a centralized content service 112 as described herein can be configured to suggest discrete commands that can be performed by one or more platforms. As with preceding examples, the ordering of the suggestion list and/or the content of the suggestion list may vary from embodiment to embodiment and user to user. For example, the commands and/or command types presented to the user may vary based on that user's history, the user's role, and so on.

More generally and broadly, the embodiments described herein refence systems and methods for sharing user interface elements rendered by a centralized content service 112 and features thereof (such as input fields or a slash command processor), between different software platforms in an authenticated and secure manner. For simplicity of description, the embodiments that follow reference a configuration in which a centralized content editing frame service is configured to implement user input fields, selectable controls, a slash command processor, or other user interface elements.

More specifically, the first platform backend 108 can be configured to communicably couple to a first platform frontend instantiated by cooperation of a memory and a processor of the client device 104. Once instantiated, the first platform frontend can be configured to leverage a display of the client device 104 to render a graphical user interface so as to present information to a user of the client device 104 and so as to collect information from a user of the client device 104. Collectively, the processor, memory, and display of the client device 104 are identified in FIG. 1 as the client devices resources 104a-104c, respectively.

As with many embodiments described herein, the first platform frontend can be configured to communicate with the first platform backend 108 and/or the centralized content service 112. Information can be transacted by and between the frontend, the first platform backend 108 and the centralized content service 112 in any suitable manner or form or format. In many embodiments, as noted above, the client device 104 and in particular the first platform frontend can be configured to send an authentication token 120 along with each request transmitted to any of the first platform backend 108 or the centralized content service 112 or the preconditioning service or the generative output engine.

Similarly, the second platform backend 110 can be configured to communicably couple to a second platform frontend instantiated by cooperation of a memory and a processor of the client device 106. Once instantiated, the second platform frontend can be configured to leverage a display of the client device 106 to render a graphical user interface so as to present information to a user of the client device 106 and so as to collect information from a user of the client device 106. Collectively, the processor, memory, and display of the client device 106 are identified in FIG. 1 as the client devices resources 106a-106c, respectively.

As with many embodiments described herein, the second platform frontend can be configured to communicate with the second platform backend 110 and/or the centralized content service 112. Information can be transacted by and between the frontend, the second platform backend 110 and the centralized content service 112 in any suitable manner or form or format. In many embodiments, as noted above, the client device 106 and in particular the second platform frontend can be configured to send an authentication token 122 along with each request transmitted to any of the second platform backend 110 or the centralized content editing frame service 112.

As a result of these constructions, the centralized content service 112 can provide uniform feature sets to users of either the client device 104 or the client device 106. For example, the centralized content service 112 can implement a user input field, selectable controls, a slash command processor, or other user interface element to receive prompt input and/or preconfigured prompt selection provided by a user of the client device 104 to the first platform and/or to receive input provided by a different user of the client device 106 to the second platform.

As noted above, the centralized content service 112 ensures that common features, such as user input interpretation, slash command handling, or other input techniques are available to frontends of different platforms. One such class of features provided by the centralized content service 112 invokes output of a generative output engine of a service such as the generative engine service 116.

For example, as noted above, the generative engine service 116 can be used to generate content, supplement content, and/or generate API requests or API request bodies that cause one or both of the first platform backend 108 or the second platform backend 110 to perform a task. In some cases, an API request generated at least in part by the generative engine service 116 can be directed to another system not depicted in FIG. 1. For example, the API request can be directed to a third-party service (e.g., referencing a callback, as one example, to either backend platform) or an integration software instance. The integration may facilitate data exchange between the second platform backend 110 and the first platform backend 108 or may be configured for another purpose.

As with other embodiments described herein, the prompt management service 114 can be configured to receive user input (provided via a graphical user interface of the client device 104 or the client device 106) from the centralized content service 112. The user input may include a prompt to be continued by the generative engine service 116.

The prompt management service 114 can be configured to modify the user input, to supplement the user input, select a prompt from a database (e.g., the database 118) based on the user input, insert the user input into a template prompt, replace words within the user input, preform searches of databases (such as user graphs, team graphs, and so on) of either the first platform backend 108 or the second platform backend 110, change grammar or spelling of the user input, change a language of the user input, and so on. The prompt management service 114 may also be referred to herein as herein as an “editor assistant service” or a “prompt constructor.” In some cases, the prompt management service 114 is also referred to as a “content creation and modification service.”

Output of the prompt management service 114 can be referred to as a modified prompt or a preconditioned prompt. This modified prompt can be provided to the generative engine service 116 as an input. More particularly, the prompt management service 114 is configured to structure an API request to the generative engine service 116. The API request can include the modified prompt as an attribute of a structured data object that serves as a body of the API request. Other attributes of the body of the API request can include, but are not limited to: an identifier of a particular LLM or generative engine to receive and continue the modified prompt; a user authentication token; a tenant authentication token; an API authorization token; a priority level at which the generative engine service 116 should process the request; an output format or encryption identifier; and so on. One example of such an API request is a POST request to a Restful API endpoint served by the generative engine service 116. In other cases, the prompt management service 114 may transmit data and/or communicate data to the generative engine service 116 in another manner (e.g., referencing a text file at a shared file location, the text file including a prompt, referencing a prompt identifier, referencing a callback that can serve a prompt to the generative engine service 116, initiating a stream comprising a prompt, referencing an index in a queue including multiple prompts, and so on; many configurations are possible).

In response to receiving a modified prompt as input, the generative engine service 116 can execute an instance of a generative output engine, such as an LLM. As noted above, in some cases, the prompt management service 114 can be configured to specify what engine, engine version, language, language model or other data should be used to continue a particular modified prompt.

The selected LLM or other generative engine continues the input prompt and returns that continuation to the caller, which in many cases may be the prompt management service 114. In other cases, output of the generative engine service 116 can be provided to the centralized content service 112 to return to a suitable backend application, to in turn return to or perform a task for the benefit of a client device such as the client device 104 or the client device 106. More particularly, it may be appreciate that although FIG. 1 is illustrated with only the prompt management service 114 communicably coupled to the generative engine service 116, this is merely one example and that in other cases the generative engine service 116 can be communicably coupled to any of the client device 106, the client device 104, the first platform backend 108, the second platform backend 110, the centralized content service 112, or the prompt management service 114.

In some cases, output of the generative engine service 116 can be provided to an output processor or gateway configured to route the response to an appropriate destination. For example, in an embodiment, output of the generative engine may be intended to be prepended to an existing document of a documentation system. In this example, it may be appropriate for the output processor to direct the output of the generative engine service 116 to the frontend (e.g., rendered on the client device 104, as one example) so that a user of the client device 104 can approve the content before it is prepended to the document. In another example, output of the generative engine service 116 can be inserted into an API request directly to a backend associated with the documentation system. The API request can cause the backend of the documentation system to update an internal object representing the document to be updated. On an update of the document by the backend, a frontend may be updated so that a user of the client device can review and consume the updated content.

In other cases, the output processor/gateway can be configured to determine whether an output of the generative engine service 116 is an API request that should be directed to a particular endpoint. Upon identifying an intended or specified endpoint, the output processor can transmit the output, as an API request to that endpoint. The gateway may receive a response to the API request which in some examples, may be directed to yet another system (e.g., a notification that an object has been modified successfully in one system may be transmitted to another system).

More generally, the embodiments described herein and with particular reference to FIG. 1 relate to systems for collecting user input, modifying that user input into a particularly engineered prompt, and submitting that prompt as input to a trained large language model. Output of the LLM can be used in a number of suitable ways.

In some embodiments, user input can be provided by text input that can be provided by a user typing a word or phrase into an editable dialog box such as a rich text editing frame rendered within a user interface of a frontend application on a display of a client device. For example, the user can type a particular character or phrase in order to instruct the frontend to enter a command receptive mode. In some cases, the frontend may render an overlay user interface that provides a visual indication that the frontend is ready to receive a command from the user. As the user continues to type, one or more suggestions may be shown in a modal UI window.

These suggestions can include and/or may be associated with one or more “preconfigured prompts” that are engineered to cause an LLM to provide particular output. More specifically, a preconfigured prompt may be a static string of characters, symbols, and words, that causes—deterministically or pseudo-deterministically—the LLM to provide consistent output. For example, a preconfigured prompt may be “generate a summary of changes made to all documents in the last two weeks.” Preconfigured prompts can be associated with an identifier or a title shown to the user, such as “Summarize Recent System Changes.” In this example, a button with the title “Summarize Recent System Changes” can be rendered for a user in a UI as described herein. Upon interaction with the button by the user, the prompt string “generate a summary of changes made to all documents in the last two weeks” can be retrieved from a database or other memory, and provided as input to the generative engine service 116.

Suggestions rendered in a UI can also include and/or may be associated with one or more configurable or “templatized prompts” that are engineered with one or more fields that can be populated with data or information before being provided as input to an LLM. An example of a templatized prompt may be “summarize all tasks assigned to ${user} with a due date in the next 2 days.” In this example, the token/field/variable ${user} can be replaced with a user identifier corresponding to the user currently operating a client device.

This insertion of an unambiguous user identifier can be performed by the client device, the platform backend, the centralized content editing frame service, the prompt management service, or any other suitable software instance. As with preconfigured prompts, templatized prompts can be associated with an identifier or a title shown to the user, such as “Show My Tasks Due Soon.” In this example, a button with the title “Show My Tasks Due Soon” can be rendered for a user in a UI as described herein. Upon interaction with the button by the user, the prompt string “summarize all tasks assigned to user123 with a due date in the next 2 days” can be retrieved from a database or other memory, and provided as input to the generative engine service 116.

Suggestions rendered in UI can also include and/or may be associated with one or more “engineered template prompts” that are configured to add context to a given user input. The context may be an instruction describing how particular output of the LLM/engine should be formatted, how a particular data item can be retrieved by the engine, or the like. As one example, an engineered template prompt may be “${user prompt}. Provide output of any table in the form of a tab delimited table formatted according to the markdown specification.” In this example, the variable ${user prompt} may be replaced with the user prompt such that the entire prompt received by the generative engine service 116 can include the user prompt and the example sentence describing how a table should be formatted.

In yet other embodiments, a suggestion may be generated by the generative engine service 116. For example, in some embodiments, a system as described herein can be configured to assist a user in overcoming a cold start/blank page problem when interacting with a new document, new issue, or new board for the first time. For example, an example backend system may be Kanban board system for organizing work associated with particular milestones of a particular project. In these examples, a user needing to create a new board from scratch (e.g., for a new project) may be unsure how to begin, causing delay, confusion, and frustration.

In these examples, a system as described herein can be configured to automatically suggest one or more prompts configured to obtain output from an LLM that programmatically creates a template board with a set of template cards. Specifically, the prompt may be a preconfigured prompt as described above such as “generate a JSON document representation of a Kanban board with a set of cards each representing a different suggested task in a project for creating a new iced cream flavor.” In response to this prompt, the generative engine service 116 may generate a set of JSON objects that, when received by the Kanban platform, are rendered as a set of cards in a Kanban board, each card including a different title and description corresponding to different tasks that may be associated with steps for creating a new iced cream flavor. In this manner, the user can quickly be presented with an example set of initial tasks for a new project.

In yet other examples, suggestions can be configured to select or modify prompts that cause the generative engine service 116 to interact with multiple systems. For example, a suggestion in a documentation system may be to create a new document content section that summarizes a history of agent interactions in an ITSM system. In some cases, the generative engine service 116 can be called more than once and/or it may be configured to generate its own follow-up prompts or prompt templates which can be populated with appropriate information and re-submitted to the generative engine service 116 to obtain further generative output. More simply, in some embodiments, generative output may be recursive, iterative, or otherwise multi-step in some embodiments.

These foregoing embodiments depicted in FIG. 1 and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

For example, it may be appreciated that all software instances described above are supported by and instantiated over physical hardware and/or allocations of processing/memory capacity of physical processing and memory hardware. For example, the first platform backend 108 may be instantiated by cooperation of a processor and memory collectively represented in the figure as the resource allocations 108a.

Similarly, the second platform backend 110 may be instantiated over the resource allocations 110a (including processors, memory, storage, network communications systems, and so on). Likewise, the centralized content service 112 is supported by a processor and memory and network connection (and/or database connections) collectively represented for simplicity as the resource allocations 112a.

The prompt management service 114 can be supported by its own resources including processors, memory, network connections, displays (optionally), and the like represented in the figure as the resource allocations 114a.

In many cases, the generative engine service 116 may be an external system, instantiated over external and/or third-party hardware which may include processors, network connections, memory, databases, and the like. In some embodiments, the generative engine service 116 may be instantiated over physical hardware associated with the host servers 102. Regardless of the physical location at which (and/or the physical hardware over which) the generative engine service 116 is instantiated, the underlying physical hardware including processors, memory, storage, network connections, and the like are represented in the figure as the resource allocations 116a.

Further, although many examples are provided above, it may be appreciated that in many embodiments, user permissions and authentication operations are performed at each communication between different systems described above. Phrased in another manner, each request/response transmitted as described above or elsewhere herein may be accompanied by user authentication tokens, user session tokens, API tokens, or other authentication or authorization credentials.

Generally, generative output systems, as described herein, should not be usable to obtain information from an organization's datasets that a user is otherwise not permitted to obtain. For example, a prompt of “generate a table of social security numbers of all employees” should not be executable. In many cases, underlying training data may be siloed based on user roles or authentication profiles. In other cases, underlying training data can be preconditioned/scrubbed/tagged for particularly sensitive datatypes, such as personally identifying information. As a result of tagging, prompts may be engineered to prevent any tagged data from being returned in response to any request. More particularly, in some configurations, all prompts output from the prompt management service 114 may include a phrase directing an LLM to never return particular data, or to only return data from particular sources, and the like.

In some embodiments, the system 100 can include a prompt context analysis instance configured to determine whether a user issuing a request has permission to access the resources required to service that request. For example, a prompt from a user may be “Generate a text summary in Document123 of all changes to Kanban board 456 that do not have a corresponding issue tagged in the issue tracking system.” In respect of this example, the prompt context analysis instance may determine whether the requesting user has permission to access Document123, whether the requesting user has written permission to modify Document123, whether the requesting user has read access to Kanban board 456, and whether the requesting user has read access to referenced issue tracking system. In some embodiments, the request may be modified to accommodate a user's limited permissions. In other cases, the request may be rejected outright before providing any input to the generative engine service 116.

Furthermore, the system can include a prompt context analysis instance or other service that monitors user input and/or generative output for compliance with a set of policies or content guidelines associated with the tenant or organization. For instance, the service may monitor the content of a user input and block potential ethical violations including hate speech, derogatory language, or other content that may violate a set of policies or content guidelines. The service may also monitor output of the generative engine to ensure the generative content or response is also in compliance with policies or guidelines. To perform these monitoring activities, the system may perform natural language processing on the monitored content in order to detect key words or phrases that indicate potential content violations. A trained model may also be used that has been trained using content known to be in violation of the content guidelines or policies.

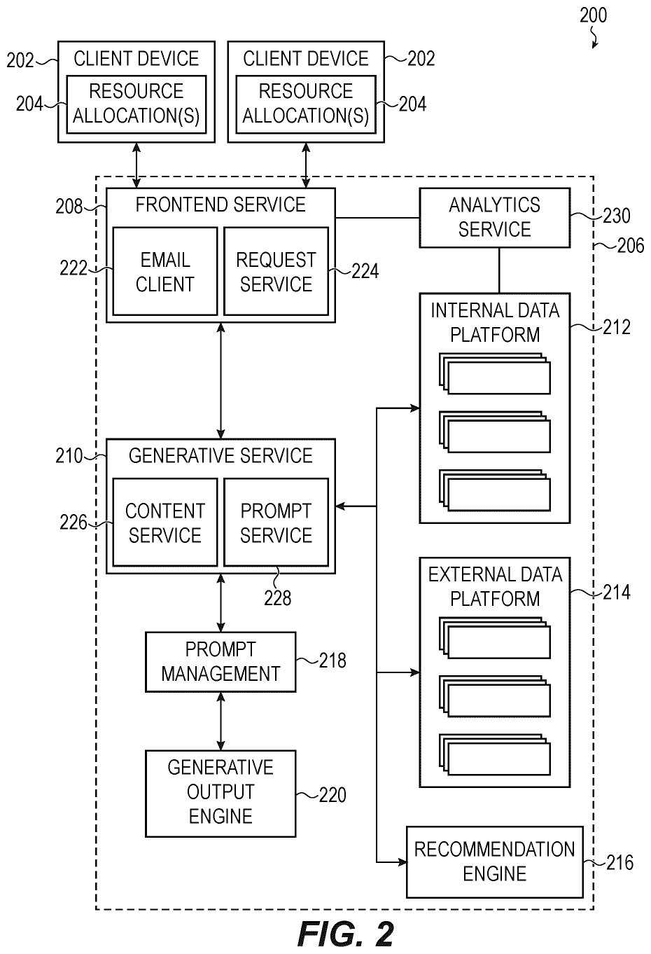

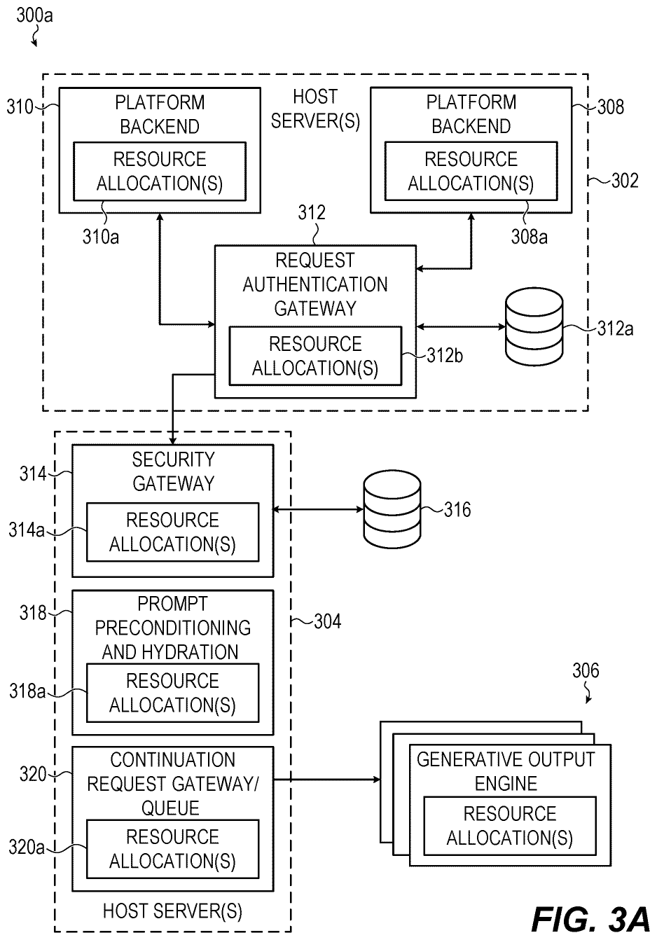

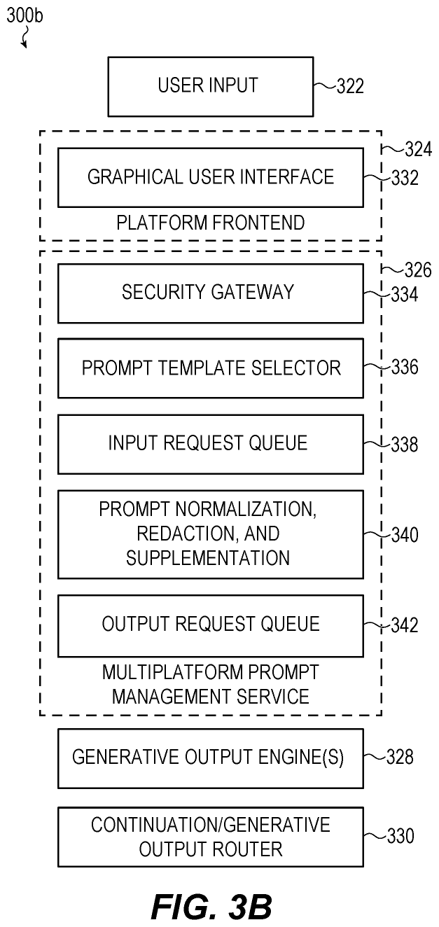

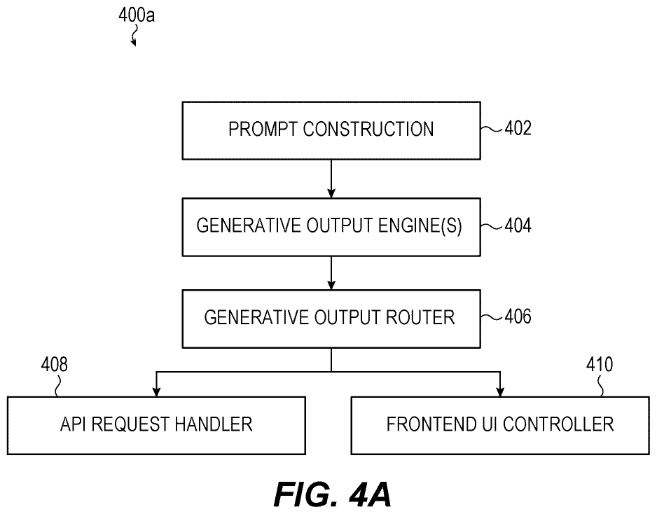

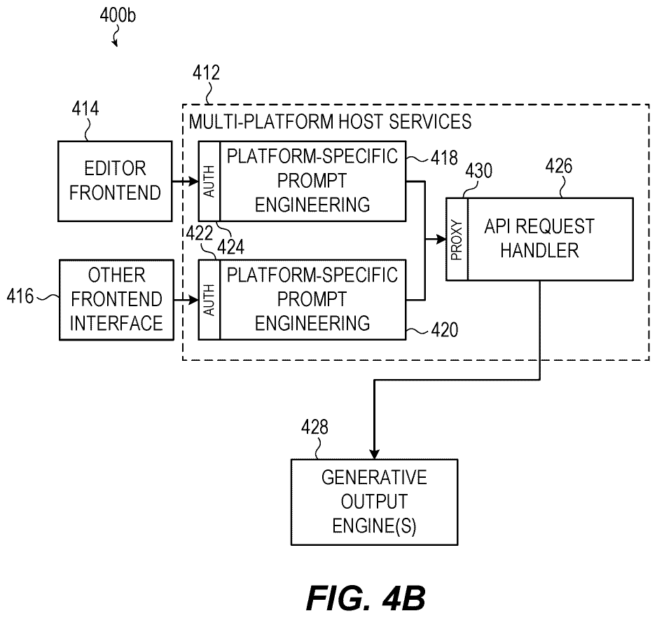

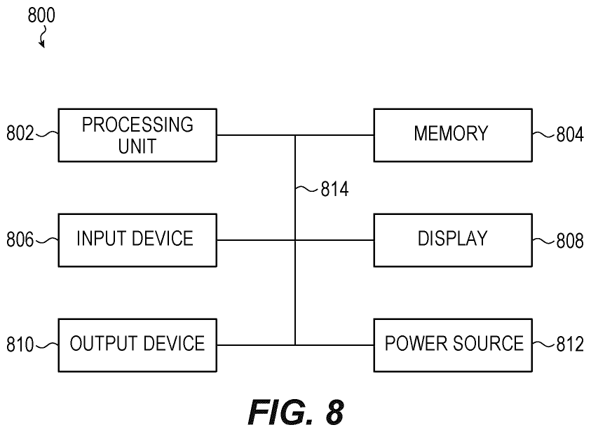

FIG. 2 depicts an example content generation system 200 for generating content for a draft message based on product usage data, as described herein. The content generation system 200 (also referred to as “system 200”) can also leverage elements and system components described above in FIG. 1 and below with respect to FIGS. 3A-4B. The system 200 can include an application platform 206 and client devices that communication via a network (e.g., the Internet). The client devices 202 may be any suitable type of device, including but not limited to a desktop or laptop computer, tablet computer, mobile phone, personal digital assistant, smart device, voice-based digital assistant, or the like. The client devices 202 may include resource allocations 204 that control operation of a respective client device. The resource allocations 204 can include, hardware, software and/or virtual resources. The electronic device described with respect to FIG. 8 provides an example of hardware resources of the client device 202.

The application platform 206 may be or may include one or more servers, content stores (e.g., databases), communications systems, data structures, programs, or other components, systems, or subsystems that provide services described herein. The application platform 206 can include one or more services that are configured to retrieve data and cause generation of prompts, as described herein. The application platform 206 can include a frontend service 208, which may operate an email client 222 on client devices 202 and/or interface with an existing (e.g., third-party) email client operating on the client devices 202. In some cases, the frontend service 208 includes a request service 224, which can be configured to communicate with a client device to initiate a content generation process, collect information from a user of a client device 202, output generated content to a user (e.g., a natural language proposed message body), receive user input at a client device 202, and in response to displaying generated content, provide other front-end functionality for the application platform 206. In some cases, the request service can cause display of one or more visual objects within an email client (or other interface) displayed on a client device 202 and provide interfaces and tools for interacting with services provided by the application platform 206.

The application platform 206 can include generative service 210. The generative service 210 may implement a content service 226, which is able take the natural language user input and/or the results received using the frontend service 208 and/or in order to formulate content requests that are served to an internal data platform 212, an external data platform 214, and a recommendation engine 216.

The content service 226 may include or have access to a registry of registered platforms or content providers (e.g., data platforms) that are accessible to the generative service 210. The registry may include an address or network location of each of the respective platforms, a list of designated content associated with each platform, and a search classifier that indicates the type or class of input that the platform is configured to use for content retrieval. For example, the search classifier may indicate which type or class of feature set that should be used with each respective platform or content provider. Some platforms are adapted to identify content using a set of key words or phrases and other platforms may be adapted to identify content using statements of intent or other semantic features. The registry may also include additional information including authentication information for platforms that provide secure content, keywords or intent classifying information that can be used for platform selection, and other data that facilitates efficient and accurate content retrieval.

The content service 226 formulates respective content requests to be provided to the prompt service 228. Each content request may include a feature set or other analysis of the user input, as generated by a respective analysis module at the frontend service 208. For secure content, the request may also include authentication data including, for example authentication credentials, an authentication token, certificate, or other data element that can be used for authenticating the user. The authentication data may be obtained from a trusted authentication service or passed along by the hosting platform or service. The content service 226 may provide access on par with or no greater than access granted to the user initiating the request or providing the user input. The content request may also be formulated in accordance with platform specific schema and, in some implementations, is provided as an application programming interface (API) call. The content requests may be paired or grouped in accordance with common or shared search classifiers such that a shared or common feature set may be used for each of the requests in the group. Grouped requests may be executed concurrently, may be executed in series, or in an order determined by content service 226.

In response to a respective content request, the internal data platform 212, the external data platform 214 and or the recommendation engine 216 may conduct a search of respective designated content in order to provide results that are passed back to the content service 226. The designated content may be stored in a shared directory, workspace, or other content partition or group. The designated content may also be distributed across a platform or content provider. In the illustrated example, the application platform 206 may include multiple groups of designated content, which may be searched in response to a single request or the request may include a particular set of designated content implicitly excluding other designated content.

In response to a series or set of content requests, the data platforms 212, 214 and/or the recommendation engine may produce a set of results, which may include content items, extracted text, aggregated search results or other forms of content corresponding to the feature sets provided in each respective request. The results returned may be aggregated by the generative service 210. The aggregated results may be processed to extract top-scoring or top-ranking results, which may be used to formulate a prompt using the prompt service 228. In one example, the aggregated results are processed by the generative service 210 to produce an aggregated set of text snippet portions. The generative service 210 may, for example identify text blocks in each content item or in the aggregated search results and may extract respective text snippet portions that include at least an extraction threshold number of sentences or phrases. For example, the first two sentences of each text block (e.g., paragraph, section, or other grouping of text) may be extracted as a text snippet portion. In other examples, the first three, four, five or six sentences or phrases are extracted from each respective text block. In some cases, the extraction threshold number of sentences is scaled for each text block such that an approximate percentage or ratio of text is extracted from each text block. In other cases, a natural language processing technique is used to identify topic and supporting sentences, which are extracted as text snippet portions. Other natural language processing techniques may eliminate text that is predicted to be contextual, redundant, or non-essential to the text block and remaining text is designated as the respective text snippet portion.

The text snippet portions that have been aggregated by the generative service 210 may be evaluated with respect to the natural language user input or a representative thereof. For example, each text snippet portion may be subjected to an embedding operation and/or generate a multi-dimensional vector representation of the text. An example embedding operation may add synonyms and predicted corresponding words to words or phrases of the respective text snippet. Additionally, the text snippets may be represented as a vector or other multi-dimensional data element allowing for comparison to a similarly vectorized or processed representation of the natural language user input. For example, a representative vector may be constructed using a word vectorization service that maps words or phrases into a vector of numbers or other characters. A comparison of each vector or other representation may be performed with respect to the user input to determine a degree of correlation or similarity. In one example implementation, a cosine similarity or other similar comparison is performed between respective vectors and a score or value is determined for each pairing. The evaluated snippets may be ranked or sorted by degree of correlation and a subset of snippets may be selected for use in constructing a prompt. In some cases, a threshold score or other degree of correlation is used to select the subset of snippets. In other cases, a threshold number of top scoring results are selected. In other examples, the top-scoring results that provide a threshold number of characters or aggregated snippet size are selected.

The selected or subset of text snippet portions may then be used by the prompt service 228 to construct a prompt that is designed to provoke a relevant and useful generative response from the generative output engine. The prompt service 228 may combine the subset of text snippet portions, context data, at least a portion of the user input, and predetermined prompt text (also referred to as predetermined query prompt text, template prompt text, or simply prompt text) in order to generate or complete the prompt that will be transmitted to the generative output engine 220. The predetermined prompt text may include one of a number of predetermined phrases that provide instructions to the generative output engine 220 including, without limitation, formatting instructions regarding a preferred length of the response, instructions regarding the tone of the response, instructions regarding the format of the response, instructions regarding prohibited words or phrases to be included in the response, context information that may be specific to the tenant or to the platform, and other predetermined instructions. In some cases, the predetermined prompt text includes a set of example input-output data pairs that may be used to provide example formatting, tone, and style of the expected generative response. In some cases, the predetermined prompt text includes special instructions to help prevent hallucinations in the response or other potential inaccuracies. The predetermined prompt text may also be pre-populated with exemplary content extracted from the platform's content item representing an ideal or reference output, which may reflect a style and tone of the tenant or content hosted on the platform.

In some implementations, the generative service 210 may also obtain or extract context data that is used to improve or further customize the prompt for a particular user, current session, or use history. In one example, the generative service 210 may obtain a user profile associated with an authenticated user operating the frontend that produced the user input. The user profile may include information about the user's role, job title, or content permissions classification, which may indicate the type of content that the user is likely to consume or produce. The role classification may be used to construct specific prompt language that is intended to tailor the generative response to the particular user or based on a persona specified by a particular user. For example, a user may specific a message tone such as “informal and polite,” the generative service 210 may add text like “provide an answer using an informal and polite tone.” Additionally or alternatively, other context data may be obtained, which may be used to generate specific text designed to prompt a particular level of detail or tone of the generative response. Other context data includes content items that are currently open or recently opened in the current session, user event logs or other logs that indicate content that has been read or produced by the authenticated user, organizational information that indicates the authenticated user's supervisors and/or reporting employees and current role, and other similar context data. In some cases, a personalized query log is referenced, which includes the user's past queries or search history and an indication of successful (or non-responsive) results, may be used as context data. Based on prior search results, the generative service 210 may further supplement to include language that improved past results or omit language that produced non-responsive or otherwise unsatisfactory results.

In some implementations, the generative service 210 may generate block-specific tags or text that is associated with each block of text inserted into the prompt. The tag may be a string of numbers and/or letters and may be used to identify the content item from which the block of text or segment of text was extracted. The tag may be an unassociated string of characters that does not inherently indicate a source of the text but can be used by the system, via a registry or some other reference object, to identify the source of the text. In other cases, the tag may include at least a portion of the content identifier, name of the content item, or other characters from which the source of the text can be directly inferred without a registry or reference object. In either configuration, the prompt may include predetermined prompt text that includes instructions for maintaining a record of tags which are used to generate the generative response. Accordingly, the generative service 210 may include a corresponding set of tags in the generative response that indicate which text blocks or snippets of text were used to generate the body of the generative response. This second set or corresponding set of tags may be used by the generative service 210 or other aspect of the system, to generate links, selectable icons, or other graphical objects that are presented to the user. Selection of the generated objects may cause a redirection of the graphical user interface to the respective content item, whether on the same platform or on a different platform. By using a tagging technique, the user may easily select a generated link in order to review the source material or to perform more extensive research into the subject matter of the generative response. If permitted by the generative output engine 220, reference to the content items (e.g., a URL or other addressable location) may be passed to the generative output engine 218 using the prompt and the prompt may include instructions to maintain or preserve the reference to the content items, which can be used to generate the links displayed in the interface with the generative response.

In accordance with other examples described herein, the prompt generated by the prompt service 228 may be communicated to the generative output engine 220 via the prompt management service 218 or prompt gateway. The prompt management service 218 may manage requests or input from multiple generative services in order to provide a single or shared gateway access to the generative output engine 220. In implementations in which the generative output engine 220 is an external service, the prompt may be communicated to the external generative output engine 220 using an application programming interface (API) call. In some cases, the prompt is provided to the generative output engine 220 using a JSON file format or other schema recognized by the generative output engine 220. If the generative output engine 220 is an integrated service, other techniques may be used to communicate the prompt to the generative output engine 220 as provided by the architecture of the platform including passing a reference or pointer to the prompt, writing the prompt to a designated location, or other similar internal data transfer technique. As described throughout herein, the generative output engine 220 may include a large language model or other predictive engine that is adapted to produce or synthesize content in response to a given prompt. The generative response is unique to the prompt and different prompts, containing different prompt text, will result in a different generative response.

In response to the prompt, the generative output engine 220 sends a generative response to the generative service 210 and/or the frontend service 208. The generative service 210, the frontend service 208, or a related service may perform post processing on the generative response including validation of the response, filtering operations to remove prohibited or non-preferred terms, elimination of potentially inaccurate phrases or terms, or performance of other post-processing operations. As discussed above, the services may also process any tags or similar items returned in the generative response that indicate the source of content that was used for the generative response. The services may generate links, icons, or other selectable objects to be rendered/displayed in the generative answer interface. Subsequent to any post-processing operations, the generative response, or portions thereof, are communicated to the frontend application for display in the generative answer interface. In some implementations, the frontend service 208 may also receive express feedback provided via the interface regarding the suitability or accuracy of the results. Frontend service 208 may also provide feedback that results from object selections, dwell time on the generative response, subsequent queries, and other user interaction events that may signal positive or negative feedback, which may be used to train intent recognition modules or other aspects of the system 200 to improve the accuracy and performance of subsequent responses.

In the present example the generative response and/or a postprocessed version of the generative response is passed back to the frontend service 208, which may cause display of at least a portion of the generative response in the generative interface or other respective interface. In the example where the input is received via the email client 222, the generative response may be displayed in a reply or draft message of the email client 222 or other interface object generated by the frontend service 208. In the example in which the user input is provided to a generative answer interface or generative interface, the response is displayed in a corresponding region of that interface.

The internal data platform 212 can store data using any suitable data structure that stores tracked client data for products and services provided as part of the multi-platform computing environment. For example, the multi-platform computing environment may include one or more integrated software platforms such as a content collaboration system, an issue tracking system, project management system, code development system, and so on. Each different software platform may have different product configurations that include different features, are intended for different numbers of users and so on.

The internal data platform 212 can be configured to store information and/or other data related to each user's usage of the system. For example, the internal data platform may store products associated with a particular user account, product usage associated with the particular user account (and/or users associated with that entity), licensing information, and/or other data related to a particular client's use of services provided by the multi-platform computing environment. In some cases, the product information can include designation of which products or services that a particular user account has access to and/or licensing information related to those products and services (e.g., seats, usage volumes, etc.). The usage information can include user-event logs or other data representative of account activity on a respective service/platform or across multiple services/platforms to which the customer account (e.g., indicated by a customer domain identifier) is subscribed to and/or has licensed. Additionally or alternatively, the product and/or product usage information may include historical usage such as initial products purchased/licensed by a user account, upgraded information, and so on.

The internal data platform 212 can be configured using any suitable data-storage functionality including relation (structured) storage formats, unstructured data formats, object-oriented data, cloud-based data storage, graph data structures, vectorized data, and so on. In some cases, the internal data platform 212 can pre-load data. For example, the internal data platform 212 can be configured to preload-specific types of data related to one or more user accounts of the system. The pre-loaded data may include product data, product usage data and so on. The pre-loading of these types of data may include storing the pre-loaded data using data structures that are readily accessible by the generative service 210, which may reduce processing time for generating a content related to a natural language message body, as described herein.

The external data platform 214 can be configured to store data that is retrieved from one or more external data sources. For example, the external data platform 214 can include data retrieved from third-party sources. For example, the system may obtain publicly available data, such as Form 8K and Form 10K data made available by the Securities and Exchange Commission (SEC) and detailing information about a specific entity that corresponds to a particular user account. The external data platform 214 can store one or more portions of this data. The obtained data can be processed using suitable methods to help efficient organization, access, and characterization of the data. For example, the obtained data can be vectorized and the second database can store the data as vectorized content.

The recommendation engine 216 can include a product model that is configured to receive a customer identifier (e.g., a customer domain identifier) and output a recommendation output specific to the customer account associated with the customer domain identifier. In some cases, the product model can include a trained machine learning model that outputs a proposed product profile and a proposed product action with respect to a particular customer account. The machine learning product model can be a model that is trained using customer specific data, product usage data, and other data related to products of a multi-platform computing environment, and is configured to output a recommendation output specific to a particular customer account.

The proposed product profile can specify one or more product recommendations for products that are not currently associated with a particular user account, but are determined, by the product model, to be relevant to the particular user account. For example, a multi-platform computing environment may include one or more integrated software platforms such as a content collaboration system, an issue tracking system, project management system, code development system, and so on. Each different software platform may have different product configurations that include different features, are intended for different numbers of users and so on. The proposed product profile can include one or more recommended configurations for the integrated software platforms.

The proposed product action can specify one or more recommended actions with respect to the proposed product profile. For example, the proposed product action includes actions related to upgrading current products, adding additional features, suggesting complimentary products, suggesting other products (e.g., managed by different software platforms), adding capability for increasing number of users, and/or other actions related to suggesting new products/features that are not currently used by a particular user account.

The content generation system 200 can include an analytics service 230, which can be configured to analyze and evaluate parameters associated with content generated by the generative output engine 220. For example, the analytics service 230 can be configured to associate actions at the system with message content that was generated by the generative output system 200. In some cases, the analytics engine 230 can evaluate how often proposed message content is accepted, modified or declined by a user of a client device 202. Additionally or alternatively, the analytics engine 230 can determine success metrics for message content by associating a sent message using generated message content with downstream sales activities such as changes to products, licenses, upgrades or other activities. The data and analytical content generated by the analytics engine 230 can be used to refine prompt generation, data retrieval, or other aspects of content generation processes described herein.

FIGS. 3A-3B depict system diagrams and network/communication architectures that may support a system as described herein. Referring to FIG. 3A, the system 300a includes a first set of host servers 302 associated with one or more software platform backends. These software platform backends can be communicably coupled to a second set of host servers 304 and purpose configured to process requests and responses to and from one or more generative output engines 306.

Specifically, the first set of host servers 302 (which, as described above can include processors, memory, storage, network communications, and any other suitable physical hardware cooperating to instantiate software) can allocate certain resources to instantiate a first and second platform backend, such as a first platform backend 308 and a second platform backend 310. Each of these respective backends can be instantiated by cooperation of processing and memory resources associated to each respective backend. As illustrated, such dedicated resources are identified as the resource allocations 308a and the resource allocations 310a.

Each of these platform backends can be communicably coupled to an authentication gateway 312 configured to verify, by querying a permissions table, directory service, or other authentication system (represented by the database 312a) whether a particular request for generative output from a particular user is authorized. Specifically, the first or second platform backend 308, 310 may be a content generation platform used by a user operating a frontend thereof.

Once the authentication gateway 312 determines that a request from a user of either platform is authorized to access data or resources implicated in service that request, the request may be passed to a security gateway 314, which may be a software instance supported by physical hardware identified in FIG. 3A as the resource allocations 314a. The security gateway 314 may be configured to determine whether the request itself conforms to one or more policies or rules (data and/or executable representations of which may be stored in a database 316) established by the organization. For example, the organization may prohibit executing prompts for offensive content, value-incompatible content, personally identifying information, health information, trade secret information, unreleased product information, secret project information, and the like. In other cases, a request may be denied by the security gateway 314 if the prompt requests beyond a threshold quantity of data.

Once a particular user-initiated prompt has been sufficiently authorized and cleared against organization-specific generative output rules, the request/prompt can be passed to a preconditioning and hydration service 318 configured to populate request-contextualizing data (e.g., user ID, page ID, project ID, URLs, addresses, times, dates, date ranges, and so on), insert the user's request into a larger engineered template prompt and so on. Example operations of a preconditioning instance are described elsewhere herein; this description is not repeated. The preconditioning and hydration service 318 can be a software instance supported by physical hardware represented by the resource allocations 318a. In some implementations, the hydration service 318 may also be used to rehydrate personally identifiable information (PII) or other potentially sensitive data that has been extracted from a request or data exchange in the system.

One a prompt has been modified, replaced, or hydrated by the preconditioning and hydration service 318, it may be passed to an output gateway 320 (also referred to as a continuation gateway or an output queue). The output gateway 320 may be responsible for enqueuing and/or ordering different requests from different users or different software platforms based on priority, time order, or other metrics. The output gateway 320 can also serve to meter requests to the generative output engines 306.

FIG. 3B depicts a functional system diagram of the system 300a depicted in FIG. 3A. In particular, the system 300b is configured to operate as a multiplatform prompt management service supporting and ordering requests from multiple users across multiple platforms. In particular, a user input 322 may be received at a platform frontend 324. The platform frontend 324 passes the input to a prompt management service 326 that formalizes a prompt suitable for input to a generative output engine 328, which in turn can provide its output to an output router 330 that may direct generative output to a suitable destination. For example, the output router 330 may execute API requests generated by the generative output engine 328, may submit text responses back to the platform frontend 324, may wrap a text output of the generative output engine 328 in an API request to update a backend of the platform associated with the platform frontend 324, or may perform other operations.

Specifically, the user input 322 (which may be an engagement with a button, typed text input, spoken input, chat box input, and the like) can be provided to a graphical user interface 332 of the platform frontend 324. The graphical user interface 332 can be communicably coupled to a security gateway 334 of the prompt management service 326 that may be configured to determine whether the user input 322 is authorized to execute and/or complies with organization-specific rules.

The security gateway 334 may provide output to a prompt selector 336 which can be configured to select a prompt template from a database of preconfigured prompts, templatized prompts, or engineered templatized prompts. Once the raw user input is transformed into a string prompt, the prompt may be provided as input to a request queue 338 that orders different user request for input from the generative output engine 328. Output of the request queue 338 can be provided as input to a prompt hydrator 340 configured to populate template fields, add context identifiers, supplement the prompt, and perform other normalization operations described herein. In other cases, the prompt hydrator 340 can be configured to segment a single prompt into multiple discrete requests, which may be interdependent or may be independent.

Thereafter, the modified prompt(s) can be provided as input to an output queue at 342 that may serve to meter inputs provided to the generative output engine 328.

These foregoing embodiments depicted in FIGS. 3A-3B and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

For example, although many constructions are possible, FIG. 4A depicts a simplified system diagram and data processing pipeline as described herein. The system 400a receives user input and constructs a prompt therefrom at operation 402. After constructing a suitable prompt, and populating template fields, selecting appropriate instructions and examples for an LLM to continue, the modified constructed prompt is provided as input to a generative output engine 404. A continuation from the generative output engine 404 is provided as input to a router 406 configured to classify the output of the generative output engine 404 as being directed to one or more destinations. For example, the router 406 may determine that a particular generative output is an API request that should be executed against a particular API (e.g., such as an API of a system or platform as described herein). In this example, the router 406 may direct the output to an API request handler 408. In another example, the router 406 may determine that the generative output may be suitably directed to a graphical user interface/frontend.

Another example architecture is shown in FIG. 4B, illustrating a system providing prompt management, and in particular multiplatform prompt management as a service. The system 400b is instantiated over cloud resources, which may be provisioned from a pool of resources in one or more locations (e.g., datacenters). In the illustrated embodiment, the provisioned resources are identified as the multi-platform host services 412.

The multi-platform host services 412 can receive input from one or more users in a variety of ways. For example, some users may provide input via an editor region 414 of a frontend, such as described above. Other users may provide input by engaging with other user interface elements 416 unrelated to common or shared features across multiple platforms. Specifically, the second user may provide input to the multi-platform host services 412 by engaging with one or more platform-specific user interface elements. In yet further examples, one or more frontends or backends can be configured to automatically generate one or more prompts for continuation by generative output engines as described herein. More generally, in many cases, user input may not be required, and prompts may be requested and/or engineered automatically.

The multi-platform host services 412 can include multiple software instances or microservices each configured to receive user inputs and/or proposed prompts and configured to provide, as output, an engineered prompt. In many cases, these instances—shown in the figure as the platform-specific prompt engineering services 418, 420—can be configured to wrap proposed prompts within engineered prompts retrieved from a database such as described above.

In many cases, the platform-specific prompt engineering services 418, 420 can each be configured to authenticate requests received from various sources. In other cases, requests from editor regions or other user interface elements of particular frontends can be first received by one or more authenticator instances, such as the authentication instances 422, 424. In other cases, a single centralized authentication service can provide authentication as a service to each request before it is forwarded to the platform-specific prompt engineering services 418, 420.

Once a prompt has been engineered/supplemented by one of the platform-specific prompt engineering services 418, 420, it may be passed to a request queue/API request handler 426 configured to generate an API request directed to a generative output engine 430 including appropriate API tokens and the engineered prompt as a portion of the body of the API request. In some cases, a service proxy 430 can interpose the platform-specific prompt engineering services 418, 420 and the request queue/API request handler 426, so as to further modify or validate prompts prior to wrapping those prompts in an API call to the generative output engine 428 by the request queue/API request handler 426 although this is not required of all embodiments.

These foregoing embodiments depicted in FIGS. 3A-3B and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

More generally, it may be appreciated that a system as described herein can be used for a variety of purposes and functions to enhance functionality of collaboration tools. Detailed examples follow. Similarly, it may be appreciated that systems as described herein can be configured to operate in a number of ways, which may be implementation specific.

For example, it may be appreciated that information security and privacy can be protected and secured in a number of suitable ways. For example, in some cases, a single generative output engine or system may be used by a multiplatform collaboration system as described herein. In this architecture, authentication, validation, and authorization decisions in respect of business rules regarding requests to the generative output engine can be centralized, ensuring auditable control over input to a generative output engine or service and auditable control over output from the generative output engine. In some constructions, authentication to the generative output engine's services may be checked multiple times, by multiple services or service proxies. In some cases, a generative output engine can be configured to leverage different training data in response to differently-authenticated requests. In other cases, unauthorized requests for information or generative output may be denied before the request is forwarded to a generative output engine, thereby protecting tenant-owned information within a secure internal system. It may be appreciated that many constructions are possible.

Additionally, some generative output engines can be configured to discard input and output once a request has been serviced, thereby retaining zero data. Such constructions may be useful to generate output in respect of confidential or otherwise sensitive information. In other cases, such a configuration can enable multi-tenant use of the same generative output engine or service, without risking that prior requests by one tenant inform future training that in turn informs a generative output provided to a second tenant. Broadly, some generative output engines and systems can retain data and leverage that data for training and functionality improvement purposes, whereas other systems can be configured for zero data retention.

In some cases, requests may be limited in frequency, total number, or in scope of information requestable within a threshold period of time. These limitations (which may be applied on the user level, role level, tenant level, product level, and so on) can prevent monopolization of a generative output engine (especially when accessed in a centralized manner) by a single requester. Many constructions are possible.

In some cases, a generative response, for example based on issue data from similar issued identified using semantic analysis, can be used to generate a user message for display in the intake portal graphical user interface using the received generative response. The user message can include a suggested action narrative and agent information. In some cases, the recommendation panel can include an option to cause the user message to be displayed in the intake portal graphical user interface. Accordingly, in response to an agent selection of the option the user message may be sent to the user via the intake portal graphical user interface.

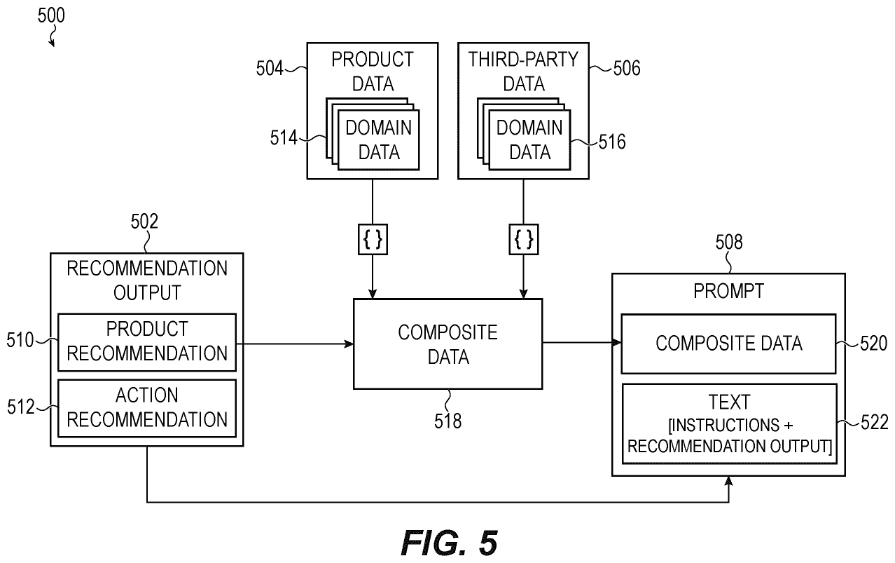

FIG. 5 depicts an example schematic 500 for obtaining product data and generating composite data for a prompt used at a generative output engine, as described herein. The schematic can illustrate processes performed by systems and methods described herein and include obtaining a recommendation output 502 from a product model, product data 504 from a first data store, third-party data 506 from a second data store; generating a composite data set 518; and using the composite data set 518 and recommendation output 502 to construct a prompt 508. The processes can be performed by the systems described herein including systems 100, 200, 300 and 400.

The recommendation output 502 can be produced by a product model (e.g., at recommendation engine and utilizing computer hardware resources described herein) that is configured to receive a customer identifier (e.g., a customer domain identifier) and output a recommendation output specific to the customer account associated with the customer domain identifier. The product model can include a trained machine learning model that outputs a proposed product profile and a proposed product action with respect to a particular customer account, as described herein. Processes performed by the product model can be performed by the recommendation engine 216 using resource allocations such as processing, memory and other hardware components, as described herein. The customer account can be an account associated with a specific entity and user accounts associated with that entity. Accordingly, in some cases, a customer account may correspond to a corporate entity account, a specific business unit account for an entity, a team of users, and/or the like.

In some cases, the product model can operate asynchronously from the content generation system and a specific content generation process initiated by a user request. For example, the product model may operate to produce recommendation outputs on a scheduled basis for multiple customer accounts and output those recommendation outputs to a data store for retrieval by the content generation system. In some cases, it may be resource and time intensive to generate the recommendation outputs. Accordingly, to reduce processing time for generating a recommendation output, the system can be configured to retrieved saved outputs from a data store. In some cases, the product model may be configured to run a pre-determined schedule (e.g., once each day, once each week, etc.) and/or in response to a specific event. Accordingly, the system may be able to access a recommendation output associated with a specific user account from a product model data-store on demand since the results are pre-saved in that data store.

In some cases, the recommendation output can include a product recommendation (i.e., a proposed product profile) and an action recommendation (i.e., a proposed product action). The proposed product profile can specify one or more product recommendations for products that are not currently associated with a particular user account, but are determined, by the product model to be relevant to the particular user account. For example, a multi-platform computing environment may include one or more integrated software platforms such as a content collaboration system, an issue tracking system, project management system, code development system, and so on. Each different software platform may have different product configurations that include different features, are intended for different numbers of users and so on. The proposed product profile can include one or more recommended configurations for the integrated software platforms.

The proposed product action can specify one or more recommended actions with respect to the proposed product profile. For example, the proposed product action may include actions related to upgrading current products, adding additional features, suggesting complimentary products, suggesting other products (e.g., managed by different software platforms), adding capability for increasing the number of users, and/or other actions related to suggesting new products/features that are not currently used by a particular user account.

In some cases, the product model can be trained on prior product data (e.g., usage data) and/or sales data (e.g., product upgrades, licensing changes, new product purchases, company information, and so on), and configured to identify products and actions that are most likely to lead to a particular user account purchasing or licensing new products, features, services and so on. In some cases, the product model can output multiple product recommendations 510 and multiple action recommendations 512. One or more product recommendations 510 can be paired with one or more action recommendations 512. In some cases, the product model can provide a score, rank, or otherwise order the product recommendations 510 and action recommendations 512 based on the likelihood of a particular customer purchasing that product using a recommendation action. For example, the recommendation output 502 may include a first paired product recommendation 510 and action recommendation 512 specifying to cross-sell a particular client a new software service. The recommendation output 502 may also include a second paired product recommendation 510 and action recommendation 512 specifying to expand licensing seats for a current software product licensed by the user account. In some cases, the recommendation output can include a metric indicating a likelihood or success or ranking of each of the paired product recommendations.

The recommendation output 502 can be used by the system to generate a composite data set 518. In some cases, the recommendation output 502 can be used to select/filter data from the product data 504 and the third-party data 506, as described herein. The product data can include information and/or other data related to each customer account's usage of the system. For example, the internal data platform may store products associated with a particular user account, product usage associated with the particular user account (and/or users associated with that entity), licensing information, and/or other data related to a particular client's use of services provided by the multi-platform computing environment. In some cases, the product information can include designation of which products or services that a particular user account has access to and/or licensing information related to those products and services (e.g., seats, usage volumes, etc.). Additionally or alternatively, the product and/or product usage information may include historical usage such as initial products purchased/licensed by a user account.

The third-party data can include data that is retrieved from one or more external data sources. For example, the system may obtain publicly available data, such as Form 8K and Form 10K data made available by the Securities and Exchange Commission (SEC) and detailing information about a specific entity that corresponds to a particular user account. The external data platform 214 can store one or more portions of this data. For example, the system can be configured to obtain data related to specific topics and/or sections of a Form 8K and/or Form 10K submission such as a “strategy” section of one or more of these documents. The obtained data can be processed using suitable methods to help efficient organization, access, and characterization of the data. For example, the obtained data can be vectorized and third-party data can be stored as vectorized content for access by the system.

In some cases, the product data 504 can include domain specific data 514, which stores data for multiple different customer accounts and the third-party data 506 can include domain specific data 516 which stores data for multiple different customer accounts. Accordingly, the product data 504 and the domain specific data may be accessed by the content generation system 200 asynchronously from the retrieval and storage of this data. This configuration of data storage may allow for quicker retrieval and processing of the product data 504 and the third-party data 506 in response to a request to generate a draft message. The product data 504 can be stored using any suitable data storage configurations, such as relational data, vectorized data, unstructured data, or other suitable data storage techniques.

The system and methods can be configured to generate the composite data 518 using the recommendation output 502 to obtain and filter data from the product data 504 and the third-party data. In some cases, the generative service 210 can generate the composite data 518 by accessing the recommendation output 502 from the recommendation engine 216, the product data from the internal data platform 212 and third-party data from the external data platform 214. Content extracted from the recommendation output 502 can be used to construct one or more queries for retrieving data associated with the particular user account. In some cases, the recommendation output 502 can be used to construct a first query for obtaining product data 504 that are related to a particular user account (e.g., a particular customer domain identifier received as part of the request). Additionally or alternatively, a semantic-based search criteria can be configured to obtain results that are related to the recommendation output (e.g., the proposed product profile and/or the proposed product action). The recommendation output 504 can be used to construct a second query for obtaining third-party data 506 using the recommendation output (e.g., the proposed product profile and/or the proposed product action), which can be used to obtain data relevant to a particular user account.

The system and methods can include using the recommendation output 502 and the composite data 518 to generate a prompt 508 for submission to a generative output engine. In some cases, the generative service 210 can be configured to generate the prompt. The prompt 508 can include prompt text 522 including instructions that utilize from the recommendation output 502 such as an action recommendation 512 (i.e., proposed product action) and/or a product recommendation 510 (i.e., a proposed product profile), which can be configured to focus the generative response content on specific products and/or actions identified in the recommendation output. Additionally or alternatively, the prompt 508 can include the composite data 520, which can be references by the prompt text 522. Accordingly, the systems and processes described herein help ensure that the data and instructions provided to a generative output engine include content that is focused on specific products and actions and that the data relates to the instructions provide in the prompt.

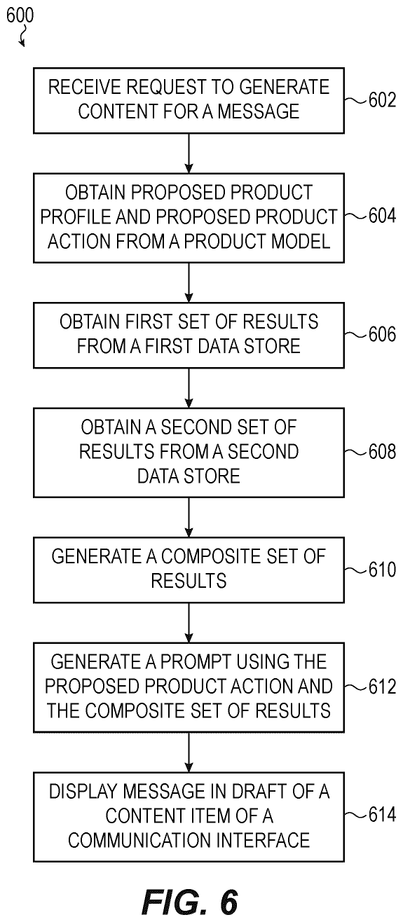

FIG. 6 depicts an example process 600 for generating content for a draft message based on product data and/or third-party data, as described herein. The process 600 can be performed using the systems described herein (e.g., systems 100, 200, 300 and/or 400) and utilizes user account data, product data and third-party data described herein (e.g., described with respect to schematic 500).

At operation 602, the process 600 includes receiving a request to generate content for a message that can be used in a draft of a content item. The request can be received from an email client managed by the generative output system 200 and/or a third-party email client that interfaces with the generative output system 200 (e.g., frontend service 208). The request may be received/processed by the front-end service. In some cases, the generative output system 200 can provide a dedicated interface, which can be used to generate a request, receive a natural language proposed message, accept, decline, revise and/or otherwise modify a natural language proposed message generated using a generative output engine as described herein. In some cases, the dedicated interface can be configured to interface with an email client, for example, to populate a message using the natural language proposed message and/or other details such as a subject line, recipient addresses and so on.

In some cases, the email client (or dedicated interface) can be configured to receive user input to a client device, which is used by the system to generate content for draft message. For example, the email client may receive and/or prompt a user for a customer domain identifier and include the customer domain identifier as part of the request to the system 200. The customer domain identifier can be any data structure that is used to identify a specific customer account, entity, business unit or account that is associated with one or more products supported by the multi-system service platform. In some cases, the domain identifier can include information that is used to identify and obtain third-party data related to a user account. For example, the domain identifier may include information associated with a business entity name that is used to obtain publicly available third-party data for that business entity (e.g., Form 8k, Form 10k data for a particular business entity).

Additional or alternatively, the email client, dedicated interface, or plug-in features for a third-party email client, can be configured to obtain other information such as a tone for the message, a persona, instructions for focusing on specific actions (e.g., new sales, up-sale, cross-sale, new client pitch, and so on) or other inputs for a user that can be used to guide generation of a natural language proposed message body.

At operation 604, the process 600 includes obtaining a recommendation output including a proposed product profile and a proposed product action from a product model, as described herein. In some cases, the generative service 210 can be configured to obtain the recommendation output from the recommendation engine 216 using one or more requests (e.g., API request or other suitable types of request). The product model can be a model that is trained using customer specific data, product usage data, and other data related to products of a multi-platform computing environment, and is configured to output a recommendation output specific to a particular customer domain identifier. In some cases, the recommendation output from the product model can include a proposed product profile and a proposed product action. The proposed product profile can specify one or more product recommendations, as described herein. The proposed product action can specify one or more recommended actions with respect to the proposed product profile, as described herein.

In some cases, the recommendation output can include multiple proposed product actions and/or multiple proposed product profiles, as described herein. In some cases, each proposed product action can be paired with a proposed product profile and/or each proposed product action and/or proposed product profile can be scored or ranked based on likelihood of success or other metric, as described herein. In some cases, obtaining a recommendation output may be an optional step and the system may be configured to obtain product information and/or a product profile using user input obtained as part of the request to generate content for a message (e.g., at operation 602).

At operation 606, the process 600 includes obtaining a first set of results from an internal data store. For example, the generative service 210 can be configured to obtain the first set of search results from the internal data platform 212. The internal data store can be an example of a product database/datastore as described herein (e.g., internal data platform 212) and include data related to products, product usage, licensing and so on. In some cases, obtaining the first set of results can include using a keyword-based search criteria that includes the customer domain identifier. The keyword-based search criteria can be configured to return results that are associated with the customer domain identifier. For example, the first query can include an exact match criteria configured to return data associated with the customer domain identifier and exclude data associated with other customer domain identifiers. The first set of search results can include identification of one or more products associated with the customer domain identifier, and product usage data that includes usage data for each respective product of the one or more products. In some cases, one or more queries used to obtain the first set of search results can include semantic-based search criteria that is constructed using the recommendation output. For example, one or more queries can include a semantic-based search criteria specifying a search parameter including at least a portion of text-based content from a proposed product action and/or a proposed product profile.

At operation 608, the process 600 includes obtaining a second set of results from an external data store. For example, the generative service 210 can be configured to obtain the first set of search results from the external data platform 214. The external data store can be an example of a third-party data store as described herein (e.g., external data platform 214) and include data that is retrieved from one or more external data sources (e.g., Form 8K data, Form 10K data, and so on), as described herein. In some cases, the external data store can include vectorized data, and obtaining the second set of search results can include generating and using a search vector. The search vector can be constructed using the recommendation output including at least a portion of text-based content (or other content) from a proposed product action and/or a proposed product profile. Additionally or alternatively, the search vector can be constructed using search results from the internal data store, for example, using product and/or usage data obtained from the first set of search results.

In some cases, the second set of search results from the second data store are obtained using a query that is performed on a version of the second data store that is generated prior to receiving the request from the client device. For example, the second data store is populated with vectorized third-party data, and the retrieval and vectorization are performed asynchronously from using one or more queries to access the second store.

In some cases, the system can be configured to generate a prompt using internal data (e.g., a first set of results obtained at operation 606) or generate the prompt using external data (e.g., a second set of results obtained at operation 608). In some cases, the system may generate multiple prompts that each include either the first set of results obtained at operation 606 or the second set of results obtained at operation 608.

At operation 610, the process 600 includes generating a composite set of results using the first set of results and the second set of results, as described herein. For example generative service 210 can be configured to generate the composite set of results. In some cases, generating the composite set of search results can be performed using relevance metrics that are returned for search results from the first data store and the second data store. For example, the system can be configured to analyze the first set of search results and determine a respective relevance score for each search result of the first set of search results and each search result of the second set of search results. The system can be configured to include search results that have a respective relevance score that satisfies metric in the composite set of search results. The system can exclude search that have a respective relevance score that does not satisfy the relevance metric. Accordingly, the composite search results can include a subset of the search results obtained from querying the first data store and the second data store.

At operation 612, the process 600 includes generating a prompt using the proposed product action and the composite set of results. The prompt can include instructions that utilize content from the recommendation output such as a proposed product action and/or a proposed product profile, as described herein. Additionally or alternatively, the prompt can include the composite data 518, as described herein. The prompt can be generated using generative service 200, as described herein.

In some cases, the prompt can include multiple requests to generate different outputs (e.g., to generate multiple different natural language proposed messages). For example, the prompt can include a first request having first instructions for the generative output engine to use a first portion of the recommendation output (e.g., a first proposed product action of the multiple proposed product actions) to generate a first version of the natural language proposed message body. The prompt can also include a second request having second instructions for the generative output engine to use a second portion of the recommendation output (e.g., a second proposed product action of the multiple proposed product actions) to generate a second version of the natural language proposed message body. In some cases, multiple prompts can be generated each having different sets of instructions. Additionally or alternatively, a same prompt can be submitted to a same or different generative output engine multiple times and outputs can be compared, analyzed and/or used to generate one or more proposed message bodies.

At operation 614, the process 600 includes displaying a draft message in a content item of a communication interface (e.g., using frontend service 208), as described herein. In some cases, the system can cause display of an option to regenerate the natural language proposed message body using feedback input to the communication interface. For example, a client may provide comments, edit, or otherwise modify the proposed message body. In response to detecting a user input to the option and receiving the feedback input, the system can cause generation of a second prompt. The second prompt can include the recommendation output obtained from the product model, the composite set of search results, the natural language proposed message body, and/or the feedback input.

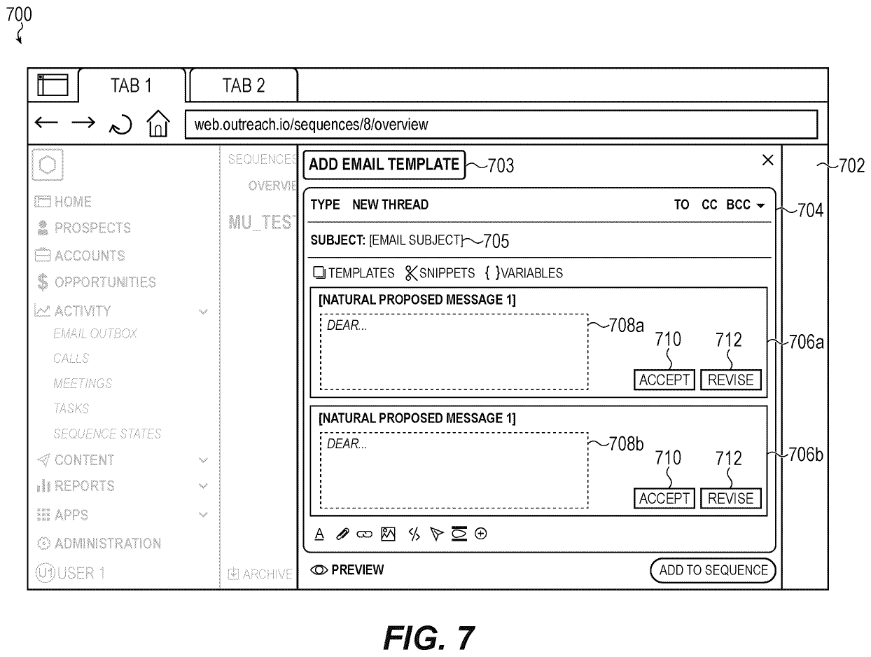

FIG. 7 depicts an example interface 700 that includes a draft of a content item 704 including a natural language proposed message body 706. The interface 700 can be an example of an email interface that is generated using an email client (e.g., email client 222) or a third-party email client that interfaces with the content generation system 200. The interface 700 can be displayed on a client device (e.g., client device 202) and be configured to receive inputs from a user of the client device.

The interface 700 can include a content pane 702, which displays content associated with a content item 704 (e.g., a draft email message). In some cases, the content pane 702 can include first object 703 for initiating a content generation process. For example, user input to the first object 703 can cause the client device to submit a request to the content generation system 200, as described herein. In some cases, the user interface 700 can include objects that are used to collect information from a user of the client device such as objects for entering or selecting a customer domain identifier or selecting a customer name, which can be used by the system to identify a customer domain identifier.

The interface 700 can display the content item 704 in response to generation of a natural language proposed message body using a generative output engine as described herein. The content item 704 can include pre-populated information which is determined using the generative response created as a result of the content creation process described herein. For example, the content item 704 can include a draft email subject 705, which can be natural language text that is included in a generative response. The content item 704 can also include one or more natural language proposed message bodies 706, which are determined using a generative response from a generative output as described herein. For example, the content item 704 may include a first natural language proposed message body 706a that includes first natural language content 708a generated in response to a prompt including composite data and recommendation output content, as described herein. The content item can include a second natural language proposed message body 706b that includes second natural language content 708b generated in response to the prompt including instructions for generating multiple outputs or a second prompt including different instructions from the prompt used to generate the first natural language proposed message body 706a.

The differing instructions and/or prompt content can cause differences in the first natural language content 708a and the second natural language content 708b. For example, a first prompt (or first prompt instructions) may focus on a first proposed product profile and corresponding proposed product action from the recommendation output and a second prompt (or second prompt instructions) may focus on a second proposed product profile and corresponding proposed product action from the recommendation output. Additionally the difference in the first proposed product profile and action and the second proposed product profile and action can cause different composite data sets to be generated from each of the first prompt and the second prompt. Accordingly, the first natural language output 708a may be tailored to a first product and action, and the second natural language output 708b may be tailored to a different product or action. Although in some cases the different natural language outputs may be based on the same or similar products and different recommendation actions, or different products and the same or similar actions.

The interface 700 can include an object 710 for accepting the corresponding natural language proposed message body and an object 712 for revising the corresponding natural language proposed message body, which can initiate a revision process as described herein (e.g., with respect to operation 614).

FIG. 8 shows a sample electrical block diagram of an electronic device 800 that may perform the operations described herein. The electronic device 800 may in some cases take the form of any of the electronic devices described with reference to FIGS. 1-7 including client devices, and/or servers or other computing devices associated with the content generation system. The electronic device 800 can include one or more of a processing unit 802, a memory or storage device 804, input devices 806, a display 808, output devices 810, and a power source 812. In some cases, various implementations of the electronic device 800 may lack some or all of these components and/or include additional or alternative components.

The processing unit 802 can control some or all of the operations of the electronic device 800. The processing unit 802 can communicate, either directly or indirectly, with some or all of the components of the electronic device 800. For example, a system bus or other communication mechanism 814 can provide communication between the processing unit 802, the power source 812, the memory 804, the input devices 806, and the output devices 810.

The processing unit 802 can be implemented as any electronic device capable of processing, receiving, or transmitting data or instructions. For example, the processing unit 802 can be a microprocessor, a central processing unit (CPU), an application-specific integrated circuit (ASIC), a digital signal processor (DSP), or combinations of such devices. As described herein, the term “processing unit” is meant to encompass a single processor or processing unit, multiple processors, multiple processing units, or other suitably configured computing element or elements.

It should be noted that the components of the electronic device 800 can be controlled by multiple processing units. For example, select components of the electronic device 800 (e.g., an input device 806) may be controlled by a first processing unit and other components of the electronic device 800 (e.g., the display 808) may be controlled by a second processing unit, where the first and second processing units may or may not be in communication with each other.

The power source 812 can be implemented with any device capable of providing energy to the electronic device 800. For example, the power source 812 may be one or more batteries or rechargeable batteries. Additionally, or alternatively, the power source 812 can be a power connector or power cord that connects the electronic device 800 to another power source, such as a wall outlet.

The memory 804 can store electronic data that can be used by the electronic device 800. For example, the memory 804 can store electronic data or content such as, for example, audio and video files, documents and applications, device settings and user preferences, timing signals, control signals, and data structures or databases. The memory 804 can be configured as any type of memory. By way of example only, the memory 804 can be implemented as random access memory, read-only memory, flash memory, removable memory, other types of storage elements, or combinations of such devices.

In various embodiments, the display 808 provides a graphical output, for example, associated with an operating system, user interface, and/or applications of the electronic device 800 (e.g., a chat user interface, an issue-tracking user interface, an issue-discovery user interface, etc.). In one embodiment, the display 808 includes one or more sensors and is configured as a touch-sensitive (e.g., single-touch, multi-touch) and/or force-sensitive display to receive inputs from a user. For example, the display 808 may be integrated with a touch sensor (e.g., a capacitive touch sensor) and/or a force sensor to provide a touch-and/or force-sensitive display. The display 808 is operably coupled to the processing unit 802 of the electronic device 800.

The display 808 can be implemented with any suitable technology, including, but not limited to, liquid crystal display (LCD) technology, light emitting diode (LED) technology, organic light-emitting display (OLED) technology, organic electroluminescence (OEL) technology, or another type of display technology. In some cases, the display 808 is positioned beneath and viewable through a cover that forms at least a portion of an enclosure of the electronic device 800.

In various embodiments, the input devices 806 may include any suitable components for detecting inputs. Examples of input devices 806 include light sensors, temperature sensors, audio sensors (e.g., microphones), optical or visual sensors (e.g., cameras, visible light sensors, or invisible light sensors), proximity sensors, touch sensors, force sensors, mechanical devices (e.g., crowns, switches, buttons, or keys), vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, electroactive polymers (EAPs), strain gauges, electrodes, and so on, or some combination thereof. Each input device 806 may be configured to detect one or more particular types of input and provide a signal (e.g., an input signal) corresponding to the detected input. The signal may be provided, for example, to the processing unit 802.

As discussed above, in some cases, the input devices 806 include a touch sensor (e.g., a capacitive touch sensor) integrated with the display 808 to provide a touch-sensitive display. Similarly, in some cases, the input devices 806 include a force sensor (e.g., a capacitive force sensor) integrated with the display 808 to provide a force-sensitive display.

The output devices 810 may include any suitable components for providing outputs. Examples of output devices 810 include light emitters, audio output devices (e.g., speakers), visual output devices (e.g., lights or displays), tactile output devices (e.g., haptic output devices), communication devices (e.g., wired, or wireless communication devices), and so on, or some combination thereof. Each output device 810 may be configured to receive one or more signals (e.g., an output signal provided by the processing unit 802) and provide an output corresponding to the signal.

In some cases, input devices 806 and output devices 810 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 802 may be operably coupled to the input devices 806 and the output devices 810. The processing unit 802 may be adapted to exchange signals with the input devices 806 and the output devices 810. For example, the processing unit 802 may receive an input signal from an input device 806 that corresponds to an input detected by the input device 806. The processing unit 802 may interpret the received input signal to determine whether to provide and/or change one or more outputs in response to the input signal. The processing unit 802 may then send an output signal to one or more of the output devices 810, to provide and/or change outputs as appropriate.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the some embodiments of the invention, whether or not such embodiments are described, and whether or not such features are presented as being a part of a described embodiment. Thus, the breadth and scope of the present invention should not be limited by any of the above-described exemplary embodiments but is instead defined by the claims herein presented.

Furthermore, the foregoing examples and description of instances of purpose-configured software, whether accessible via API as a request-response service, an event-driven service, or whether configured as a self-contained data processing service are understood as not exhaustive. The various functions and operations of a system, such as described herein, can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, which are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed only for legitimate, agreed-upon, and reasonable uses.

What is claimed is:

1. A method for generating content for a draft message based on tracked product usage data and pre-processed vectorized data, the method comprising:
in response to receiving a request from a client device, extracting a customer domain identifier from the request;
using the customer domain identifier, obtaining from a product model a proposed product profile and a proposed product action;
using the customer domain identifier and the proposed product profile, constructing a first query comprising a semantic-based search criteria and a keyword-based search criteria;
obtaining a first set of search results from an internal data store using the first query, the internal data store including product usage data with respect to a customer account associated with the customer domain identifier;
using the customer domain identifier and the proposed product profile, constructing a second query comprising a search vector;
obtaining a second set of search results from a second data store using the second query, the second data store including vectorized content obtained from an external data source;
analyzing the first set of search results and the second set of search results to compute a relevance score using the proposed product profile and the proposed product action;
generating a composite set of search results including at least a portion of the first set of search results and the second set of search results having a relevance score satisfying a relevance metric;
causing generation of a prompt comprising:
the proposed product action obtained from the product model; and
the composite set of search results satisfying the relevance metric;
providing the prompt to a generative output engine to receive a generative response;
analyzing the generative response to generate a natural language proposed message body;
causing display of the natural language proposed message body in a draft of a content item of a communication interface; and
in response to a user input provided to the communication interface, causing the draft of the content item to be transmitted to a recipient associated with the customer domain identifier.

2. The method of claim 1, wherein:
analyzing the first set of search results comprises determining a respective relevance score for each search result of the first set of search results and each search result of the second set of search results; and
the composite set of search results comprises each search result having a respective relevance score that satisfies the relevance metric and excludes each search result that does not satisfy the relevance metric.

3. The method of claim 1, wherein:
the keyword-based search criteria comprises the customer domain identifier; and
the first query comprises an exact match criteria configured to return data associated with the customer account and exclude data associated with other customer accounts.

4. The method of claim 1, wherein:
the first set of search results comprise identification of one or more products associated with the customer domain identifier; and
the product usage data comprises usage data for each respective product of the one or more products.

5. The method of claim 1, wherein:
the semantic-based search criteria is constructed using the proposed product action; and
the search vector is constructed using the proposed product action.

6. The method of claim 1, wherein:
the product model outputs multiple proposed product actions;
the prompt comprises a first request comprising a first instruction for the generative output engine to use a first proposed product action of the multiple proposed product actions to generate a first version of the natural language proposed message body; and
the prompt comprises a second request comprising a second instruction for the generative output engine to use a second proposed product action of the multiple proposed product actions to generate a second version of the natural language proposed message body.

7. The method of claim 1, wherein, in response to causing display of the natural language proposed message body in the draft of the content item of the communication interface, the method comprises causing display of an option to regenerate the natural language proposed message body using feedback input to the communication interface.

8. The method of claim 1, wherein obtaining the second set of search results from the second data store using the second query is performed on a version of the second data store generated prior to receiving the request from the client device.

9. A method for generating content for a draft message based on tracked product usage data and pre-processed vectorized data, the method comprising:
in response to receiving a request from a client device, extracting a customer domain identifier from the request;
using the customer domain identifier, obtaining from a product model a recommendation output for a customer account associated with the customer domain identifier;
using the customer domain identifier and the recommendation output, constructing a first query;
obtaining a first set of search results from an internal data store using the first query, the internal data store including product usage data with respect to one or more customer accounts including the customer account;
using the customer domain identifier and the recommendation output, constructing a second query;
obtaining a second set of search results from a second data store using the second query, the second data store including content generated from an external data source;
generating a composite set of search results comprising search results from the first set of search results and the second set of search results having a respective relevance score satisfying a relevance metric;
causing generation of a prompt comprising:
the recommendation output obtained from the product model; and
the composite set of search results;
providing the prompt to a generative output engine to receive a generative response;
analyzing the generative response to generate a natural language proposed message body;
causing display of the natural language proposed message body in a draft of a content item of a communication interface; and
in response to a user input provided to the communication interface, causing the content item to be transmitted to a recipient associated with the customer domain identifier.

10. The method of claim 9, wherein:
the first query is configured to obtain current products associated with the customer account, usage data for each of the current products; licensing data for each of the current products; and
the second query comprises a search vector constructed using the first set of search results.

11. The method of claim 9, wherein the recommendation output comprises a proposed product profile and a proposed product action.

12. The method of claim 9, wherein the first query comprises a keyword-based search criteria that is configured to return data associated with the customer account and exclude data associated with other customer accounts.

13. The method of claim 9, wherein:
the product model outputs multiple recommendation outputs; and
the prompt comprises a request to generate multiple versions of the natural language proposed message body.

14. The method of claim 9, wherein, in response to causing display of the natural language proposed message body in the draft of the content item of the communication interface, the method comprises causing display of an option to regenerate the natural language proposed message body using feedback input to the communication interface.

15. The method of claim 14, wherein in response to detecting a user input to the option and receiving the feedback input, causing generation of a second prompt comprising:
the recommendation output obtained from the product model;
the composite set of search results;
the natural language proposed message body; and
the feedback input.

16. A content generation system backend application operating on one or more servers, the content generation system backend application operably coupled to a frontend application operating on a client device, the content generation system backend application configured to:
extract a customer domain identifier from a request received by the content generation system backend application;
obtain, from a product model, a recommendation output using the customer domain identifier;
construct a query comprising a semantic-based search criteria and a keyword-based search criteria using the recommendation output;
obtain a set of search results from an internal data store using the query, the internal data store including product usage data with respect to a customer account associated with the customer domain identifier;
generate a composite set of search results including at least a portion of the set of search results having a relevance score satisfying a relevance metric;
cause generation of a prompt comprising:
the recommendation output; and
the composite set of search results satisfying the relevance metric;
provide the prompt to a generative output engine to receive a generative response;
analyze the generative response to generate a natural language proposed message body;
cause display of the natural language proposed message body in a draft of a content item of a communication interface; and
in response to a user input provided to the communication interface, cause the draft of the content item to be transmitted to a recipient associated with the customer domain identifier.

17. The system of claim 16, wherein the recommendation output comprises a proposed product profile and a proposed product action.

18. The system of claim 16, wherein:
analyzing the set of search results comprises determining a respective relevance score for each search result of the set of search results; and
the composite set of search results comprises each search result having a respective relevance score that satisfies the relevance metric and excludes each search result that does not satisfy the relevance metric.

19. The system of claim 16, wherein:
the product model outputs multiple recommendation outputs; and
the prompt comprises a request to generate multiple versions of the natural language proposed message body.

20. The system of claim 16, wherein obtaining the second set of search results from the second data store using the second query is performed on a version of the second data store that is generated prior to receiving the request from the client device.
